(19) United States
(12) Patent Application Publication
(10) Pub. No.: US 2023/0261265 A1
(43) Pub. Date: Aug. 17, 2023

(54) METHOD FOR FABRICATING SECONDARY BATTERY

(71) Applicant: SEMICONDUCTOR ENERGY LABORATORY CO., LTD., Atsugi-shi, Kanagawa-ken (JP)

(72) Inventors: Shunpei YAMAZAKI, Setagaya,Tokyo (JP); Tetsuya KAKEHATA, sehara, Kanagawa (JP); Tetsuji ISHITANI, Atsugi, Kanagawa (JP); Shuhei YOSHITOMI, Ayase, Kanagawa (JP)

(21) Appl. No.: 18/004,749

(22) PCT Filed: Jul. 13, 2021
(86) PCT No.: PCT/IB2021/056266

§ 371 Date: Jan. 9, 2023

(30) Foreign Application Priority Data
Jul. 24, 2020 (JP) 2020-125998

(51) Int. Cl. H01M 10/0585

(52) U.S. Cl. CPC H01M 10/0585

(57) ABSTRACT

One embodiment of the present invention achieves a fabrication method that can automate fabrication of a secondary battery. In addition, a fabrication method that can fabricate a secondary battery efficiently in a short time is achieved. Furthermore, a fabrication method that can fabricate a secondary battery with high yield is achieved. Alternatively, a method for fabricating a large secondary battery with a relatively large size is achieved. An electrolyte is dripped on one or more of a positive electrode, a separator, and a negative electrode; the one or more of the positive electrode, the separator, and the negative electrode are impregnated with the electrolyte; pressure is then reduced; and a stack of the positive electrode, the separator, and the negative electrode is sealed with an exterior film. A plurality of stacks may be arranged on an exterior film; a plurality of drops of an electrolyte may be dripped on the stacks; sealing may be performed under reduced pressure; and then the exterior film may be divided into separate secondary batteries.

### TECHNICAL FIELD

One embodiment of the present invention relates to a secondary battery and a fabrication method thereof. Other embodiments of the present invention relate to a portable information terminal, a vehicle, and the like each including a secondary battery.

One embodiment of the present invention relates to an object, a method, or a manufacturing method. The present invention relates to a process, a machine, manufacture, or a composition of matter. One embodiment of the present invention relates to a semiconductor device, a display device, a light-emitting device, a power storage device, a lighting device, an electronic device, or a manufacturing method thereof.

Note that electronic devices in this specification mean all devices including power storage devices, and electro-optical devices including power storage devices, information terminal devices including power storage devices, and the like are all electronic devices.

Note that in this specification, a power storage device refers to every element and device having a function of storing power. For example, a power storage device (also referred to as a secondary battery) such as a lithium-ion secondary battery, a lithium-ion capacitor, and an electric double layer capacitor are included.

### BACKGROUND ART

In recent years, a variety of power storage devices such as lithium-ion secondary batteries, lithium-ion capacitors, and air batteries have been actively developed. In particular, demand for lithium-ion secondary batteries with high output and high energy density has rapidly grown with the development of the semiconductor industry, for portable information terminals such as mobile phones, smartphones, and laptop computers, portable music players, digital cameras, medical equipment, next-generation clean energy vehicles such as hybrid electric vehicles (HVs), electric vehicles (EVs), and plug-in hybrid electric vehicles (PHVs), and the like, and the lithium-ion secondary batteries are essential as rechargeable energy supply sources for today's information society.

A lithium-ion secondary battery is composed of a positive electrode containing a positive electrode active material such as lithium cobalt oxide (LiCoO₂) or lithium iron phosphate (LiFePO₄), a negative electrode containing a negative electrode active material such as a carbon material, e.g., graphite capable of occluding and releasing lithium, and an electrolyte containing an organic solvent such as ethylene carbonate (EC) or diethyl carbonate (DEC), for example.

For the lithium-ion secondary batteries, high capacity, higher performance, safety in various operating environments, and the like are required.

Patent Document 1 discloses a manufacturing apparatus for a laminated battery, which can improve manufacturing efficiency.

### REFERENCE

### Patent Document

### [Patent Document 1]

Japanese Published Patent Application No. 2017-117729

### SUMMARY OF THE INVENTION

### Problems to be Solved by the Invention

An object is to achieve a fabrication method that can automate fabrication of a secondary battery. Another object is to achieve a fabrication method that can fabricate a secondary battery efficiently in a short time. Another object is to achieve a fabrication method that can fabricate a secondary battery with high yield.

Another object is to achieve a method for fabricating a secondary battery with a relatively large size.

Another object is to provide a method for fabricating a secondary battery with lower manufacturing cost.

Another object is to provide a method for fabricating a highly safe or reliable secondary battery.

Note that the description of these objects does not preclude the existence of other objects. One embodiment of the present invention does not have to achieve all the objects. Other objects can be derived from the description of the specification, the drawings, and the claims.

### Means for Solving the Problems

Conventionally, secondary batteries are often fabricated in the following manner: a stack of a positive electrode, a separator, and a negative electrode is put in a can or a bag-like exterior body, an electrolyte solution is injected thereinto, and then sealing is performed. The conventional method might easily cause outward diffusion of lithium ions from an inlet. In addition, with the conventional method, the number of steps tends to increase and it is sometimes difficult to accurately adjust the injection amount of the electrolyte solution. Accurate injection of a necessary amount of the electrolyte solution for a secondary battery can lead to mass production of secondary batteries with uniform properties.

In one invention disclosed in this specification, a plurality of drops of an electrolyte are dripped on any one or more of a positive electrode, a separator, and a negative electrode for uniform impregnation. After that, a stack of the positive electrode, the separator, and the negative electrode is sandwiched by an exterior film such that outer edges (four sides when seen from above, in the case where a three-dimensional shape of a secondary battery is a thin rectangular solid) are sealed without any space. Shown here is mainly an example of a thin battery (also referred to as a laminated type). Note that an external extraction terminal (e.g., a lead wiring or a lead electrode (also referred to as a lead terminal)) is made to project outside the exterior film. The lead terminal is provided to lead the positive electrode or the negative electrode of the secondary battery to the outside of the exterior film. Note that sealing is preferably performed under reduced pressure, which is lower than at least atmospheric pressure, in order to prevent mixing of impurities.

The plurality of drops of the electrolyte are dripped at a time or in a plurality of steps at a uniform pitch on a plane of a surface where the drops are dripped. As a dripping method, any one of a dispensing method, a spraying method, an inkjet method, and the like can be used. A dispensing method is a method using a quantitative liquid discharge apparatus, which enables a constant amount of drops to be dripped from a nozzle. The use of a plurality of quantitative liquid discharge apparatuses can shorten the manufacturing time. When the nozzle or an object on which the drops are dripped (any one or more of the positive electrode, the separator, and the negative electrode) is moved relatively, the dripping can be performed at regular intervals. Assuming that the dripping amount on one portion with a certain nozzle diameter is 0.01 cc, dripping on n (n>1) portions enables impregnation with the electrolyte with the amount of 0.01 cc×n, so that the falling points of the drops or the total dripping amount can be precisely controlled. In the case of the positive electrode, for example, dripping on n (n>1) portions of a plane can shorten the time for impregnating the entire positive electrode with the electrolyte as compared with dripping on only one portion of the positive electrode, thereby reducing the manufacturing time.

The viscosity of the electrolyte dripped from the nozzle or the like is preferably adjusted as appropriate. When the viscosity of the whole electrolyte falls within the range from 10 mPa·s to 95 mPa s at room temperature (25° C.), the electrolyte can be dripped from the nozzle. Note that the viscosity is measured with a rotating viscometer (TVE-35L, produced by Toki Sangyo Co., Ltd.).

As the electrolyte to be dripped, an organic solvent or an ionic liquid can be used.

After the dripping of the electrolyte, sealing under reduced pressure is preferably performed. Thus, in the case where the dripping and the sealing are performed successively, it is preferable to use the same chamber or a plurality of joined chambers. For example, it is preferable that, after the dripping of the electrolyte in a first chamber, transfer to a second chamber be conducted without exposure to the air, pressure in the second chamber be reduced, and then the stack be sealed with the exterior film in the second chamber because mixing of impurities such as dust can be prevented. Alternatively, the dripping of the electrolyte and the sealing with the exterior film may be successively performed in the same chamber, in which case a secondary battery can be fabricated efficiently.

The chamber for sealing is connected to a vacuum evacuation treatment chamber, can be made in a vacuum by vacuum evacuation, and can be made in atmospheric pressure by introduction of an inert gas after the vacuum evacuation. The vacuum evacuation treatment chamber is provided with a magnetic levitation turbomolecular pump, a cryopump, or a dry pump. This enables the ultimate vacuum of the chamber for sealing to be from 10⁻⁵ Pa to approximately 10⁻⁶ Pa, and back diffusion of impurities from the pump side and an exhaust system can be controlled. An inert gas such as nitrogen or a rare gas is used as a gas to be introduced in order to prevent the impurities from being introduced into the apparatus. A gas that is highly purified by a gas purifier before the introduction into the apparatus is used as the gas to be introduced into the apparatus.

An ionic liquid is preferable because it hardly volatilizes under reduced pressure even at a high vacuum. As the electrolyte, a mixture of an ionic liquid and an organic solvent may be used. In the case where an organic solvent is contained as the electrolyte, the degree of vacuum in a chamber is set at a low vacuum lower than approximately 5×10⁻¹ Pa.

In a structure of the invention disclosed in this specification, an electrolyte is dripped on one or more of a positive electrode, a negative electrode, and a separator; the one or more of the positive electrode, the negative electrode, and the separator are impregnated with the electrolyte; pressure is then reduced; and a stack of the positive electrode, the separator, and the negative electrode is sealed with an exterior film.

With the use of a large-area exterior film, a large number of secondary batteries can be fabricated at a time. A method for fabricating a plurality of secondary batteries efficiently from one large-area exterior film such as a large-area exterior film with an exterior film size of, for example, 320 mm×400 mm, 370 mm×470 mm, 550 mm×650 mm, 600 mm×720 mm, 680 mm×880 mm, 1000 mm×1200 mm, 1100 mm×1250 mm, or 1150 mm×1300 mm can be provided. Furthermore, a method for fabricating a secondary battery suitable for mass production using a large-area exterior film having an exterior film size of, for example, 1500 mm×1800 mm, 1800 mm×2000 mm, 2000 mm×2100 mm, 2200 mm×2600 mm, or 2600 mm×3100 mm is provided.

Another structure relating to a fabrication method disclosed in this specification is a method for fabricating a secondary battery, in which a plurality of stacks are arranged on an exterior film, a plurality of drops of an electrolyte are dripped on the stacks, sealing is performed under reduced pressure, and then the exterior film is divided into separate secondary batteries, and the stacks each include at least two or more of a positive electrode, a separator, and a negative electrode. Note that the exterior film can be divided using laser light or the like.

The use of a film (also referred to as a laminate film) including a stack of metal foil (e.g., aluminum or stainless steel) and a resin (heat-seal resin) as the exterior film allows fabrication of a thin secondary battery that is more lightweight than a secondary battery using a metal can. Metal foil having an adhesive layer on one or both surfaces is used. Thermocompression bonding is performed in the state where a first adhesive layer of a first laminate film and a second adhesive layer of a second laminate film are attached closely to each other such that the first adhesive layer and the second adhesive layer are positioned inside, so that a seal region is formed. There is no limitation on thermocompression bonding, and a sealant may be drawn on a seal region using a thermosetting resin, an ultraviolet curable resin, or the like.

The seal region has a frame-like shape or a closed-loop shape. The stack of the positive electrode, the separator, and the negative electrode is placed in a region surrounded by the seal region to be hermetically sealed. Thus, the area of the region surrounded by the seal region is larger than at least the area of the positive electrode of the secondary battery.

A film used as the exterior body of the secondary battery is a single-layer film selected from a metal film (e.g., foil of a metal such as aluminum, stainless steel, nickel steel, gold, silver, copper, titanium, nichrome, iron, tin, tantalum, niobium, molybdenum, zirconium, or zinc or an alloy thereof), a plastic film made of an organic material, a hybrid material film containing an organic material (e.g., an organic resin or fiber) and an inorganic material (e.g., ceramic), and a carbon-containing inorganic film (e.g., a carbon film or a graphite film) or a stacked-layer film including a plurality of the above films.

A sealing structure of a secondary battery is a structure in which one rectangular exterior film is folded in half such that two end portions, between which the folded portion is sandwiched, of the four corners overlap with each other and is fixed and sealed on four sides with an adhesive layer. With such a structure, the stack of the positive electrode, the separator, and the negative electrode is stored to be surrounded by the exterior film. Alternatively, a structure is employed in which two exterior films overlap with each other and are fixed and sealed on four sides of the exterior films with an adhesive layer. In this specification, an exterior film after sealing is sometimes referred to as an exterior body instead of an exterior film.

The case of using two exterior films also has a feature in a fabrication method; a structure relates to a method for fabricating a secondary battery, in which a positive electrode is placed over a first exterior film, a first electrolyte is dripped on the positive electrode, a separator is placed over the positive electrode, a second electrolyte is dripped on the separator, a negative electrode is placed over the separator, a third electrolyte is dripped on the negative electrode, a stack of the positive electrode, the separator, and the negative electrode is placed under reduced pressure, and the stack is sandwiched between the first exterior film and a second exterior film to be sealed. Sealing refers to shielding a hermetically sealed region from the outside air; in a secondary battery, a stack and its outer edge are regarded as a hermetically sealed region, and shielding the hermetically sealed region from the outside air by surrounding the outside of the hermetically sealed region with one or two exterior films is referred to as sealing. After sealing, the end portions of the exterior film are folded to increase the sealing strength, thereby preventing entry of impurities from the outside or release of a gas or the like from the inside.

In the above structure, the first electrolyte, the second electrolyte, and the third electrolyte may be either the same material or different materials. In each of the above structures, the stack may be either a stack in which the positive electrode, the separator, and the negative electrode are stacked in this order or a stack in which the negative electrode, the separator, and the positive electrode are stacked in this order. The separator is used to prevent a short circuit between the positive electrode and the negative electrode; in the case where the stacks overlap with each other to increase the capacity, one common separator may be folded and used to reduce the number of components.

The adhesive layer (also referred to as a heat-seal layer) can be formed using a thermoplastic film material, a thermosetting adhesive, an anaerobic adhesive, a photo-curable adhesive such as an ultraviolet curable adhesive, or a reactive curable adhesive. As the materials of these adhesives, an epoxy resin, an acrylic resin, a silicone resin, a phenol resin, and the like can be used.

For the current collectors such as the positive electrode current collector and the negative electrode current collector, a highly conductive material that is not alloyed with a carrier ion such as a lithium ion, e.g., a metal such as stainless steel, gold, platinum, zinc, iron, nickel, copper, aluminum, titanium, and tantalum or an alloy thereof can be used. It is also possible to use an aluminum alloy to which an element that improves heat resistance, such as silicon, titanium, neodymium, scandium, or molybdenum, is added. A metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. Furthermore, the current collector having a foil-like shape, a plate-like shape (sheet-like shape), a net-like shape, a cylindrical shape, a coil shape, a punching-metal shape, an expanded-metal shape, or the like can be used as appropriate. The current collector preferably has a thickness greater than or equal to 10 μm and less than or equal to 30 μm.

The examples of the thin battery (laminated type) are mainly described above; however, one embodiment of the present invention is not particularly limited thereto and can also be applied to a wound battery. In the case of a wound battery, an electrolyte is dripped on a wound body or dripping is performed before a wound body is formed, i.e., before winding is performed. A wound body refers to an object in which a belt-shaped positive electrode, a belt-shaped separator, and a belt-shaped negative electrode overlap with each other in this order and winding is performed while they are kept to overlap with each other.

### Effect of the Invention

Since the number of sealing steps of a secondary battery is small, the fabrication process of the secondary battery can be significantly shortened. Thus, a method for fabricating a secondary battery with lower manufacturing cost can be provided. Alternatively, a method for fabricating a secondary battery efficiently in a short time can be achieved. Alternatively, a fabrication method that can automate fabrication of a secondary battery can be achieved. Alternatively, a method for fabricating a secondary battery with high yield can be achieved.

Alternatively, a method for fabricating a large secondary battery with a relatively large size can be achieved. In the case of mounting a secondary battery with high capacity, the number of large secondary batteries to be mounted can be smaller than the number of small secondary batteries to be mounted. A reduction in the number of large secondary batteries to be mounted allows easy control of each secondary battery and reduces a load on a charge control circuit.

Alternatively, a secondary battery obtained by the fabrication method disclosed in this specification can have a high level of safety or high reliability because firm sealing can be performed through one sealing step.

### BRIEF DESCRIPTION OF THE DRAWINGS

FIG. 1A is a schematic cross-sectional view of a secondary battery showing one embodiment of the present invention, FIG. 1B is a top view after dripping of an electrolyte, and FIG. 1C is an example of a top view in the case of multiple formation.

FIG. 2 is a flow chart showing an example of a method for fabricating a secondary battery of one embodiment of the present invention.

FIG. 3A, FIG. 3B, FIG. 3C, FIG. 3D, and FIG. 3E are cross-sectional views illustrating an example of a method for fabricating a secondary battery of one embodiment of the present invention.

FIG. 4 is a diagram illustrating crystal structures of a positive electrode active material.

FIG. 5 is a diagram illustrating crystal structures of a positive electrode active material.

FIG. 6A, FIG. 6B, and FIG. 6C are external views of a secondary battery.

FIG. 7A and FIG. 7B are external views of a secondary battery.

FIG. 8A, FIG. 8B, and FIG. 8C are diagrams illustrating a method for fabricating a secondary battery.

FIG. 9A is a perspective view illustrating a battery pack, FIG. 9B is a block diagram of the battery pack, and FIG. 9C is a block diagram of a vehicle having a motor.

FIG. 10A to FIG. 10D are diagrams illustrating examples of transport vehicles.

FIG. 11A and FIG. 11B are diagrams illustrating a power storage device.

FIG. 12A, FIG. 12B, FIG. 12C, FIG. 12D, and FIG. 12E are perspective views of electronic devices showing one embodiment of the present invention.

### MODE FOR CARRYING OUT THE INVENTION

Embodiments of the present invention will be described in detail below with reference to the drawings. Note that the present invention is not limited to the following description, and it is readily understood by those skilled in the art that modes and details of the present invention can be modified in various ways. In addition, the present invention should not be construed as being limited to the description of the following embodiments.

### Embodiment 1

In this embodiment, a secondary battery of one embodiment of the present invention, a fabrication method thereof, and the like will be described.

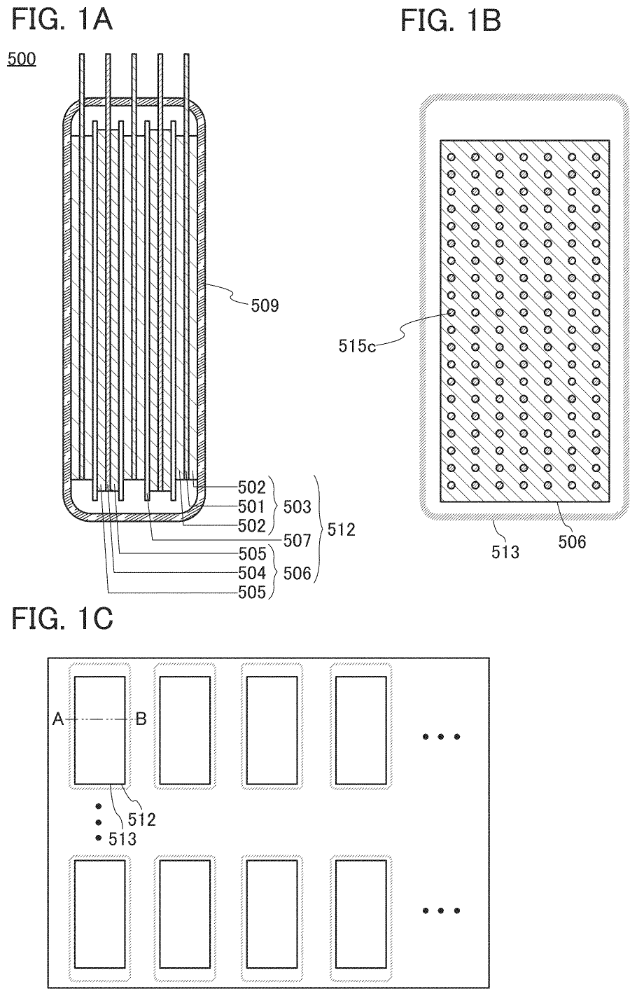

An example of a secondary battery of one embodiment of the present invention will be described with reference to FIG. 1A.

A secondary battery 500 illustrated in FIG. 1A includes an exterior body 509 and a stack 512 placed in the exterior body 509. The stack 512 includes a positive electrode 503, a negative electrode 506, and a separator 507. In the stack 512, the positive electrode 503 and the negative electrode 506 overlap with each other with the separator 507 placed therebetween.

The positive electrode 503 includes a positive electrode current collector 501 and positive electrode active material layers 502 provided on both surfaces of the positive electrode current collector 501. Note that the positive electrode active material layer 502 may be provided on only one surface of the positive electrode current collector 501.

The negative electrode 506 includes a negative electrode current collector 504 and negative electrode active material layers 505 provided on both surfaces of the negative electrode current collector 504. Note that the negative electrode active material layer 505 may be provided on only one surface of the negative electrode current collector 504.

The positive electrode active material layer 502 and the negative electrode active material layer 505 are preferably placed to face each other with the separator 507 therebetween. FIG. 1A illustrates an example in which the secondary battery includes four pairs each including the positive electrode active material layer 502 and the negative electrode active material layer 505 that face each other with the separator 507 therebetween.

The positive electrode 503 includes a region where the positive electrode current collector 501 is partly exposed (hereinafter, referred to as a tab region). The negative electrode 506 includes a region where the negative electrode current collector 504 is partly exposed, that is, a tab region.

In a plurality of positive electrode current collectors 501, for example, the tab regions are placed to overlap with each other. The overlapping tab regions and a positive electrode lead electrode may overlap with each other and may be bonded to each other by ultrasonic welding or the like. In a plurality of negative electrode current collectors 504, for example, the tab regions are placed to overlap with each other. The overlapping tab regions and a negative electrode lead electrode may overlap with each other and may be bonded to each other by ultrasonic welding or the like. The timing of bonding using ultrasonic welding or the like is selected as appropriate by a practitioner; the bonding may be performed either before sealing or after sealing.

In the secondary battery of one embodiment of the present invention, a plurality of drops of an electrolyte are dripped on any one or more of the positive electrode, the negative electrode, and the separator for uniform impregnation. FIG. 1B illustrates an example in which a plurality of drops of an electrolyte are dripped on the negative electrode. The negative electrode includes the negative electrode active material layer over the negative electrode current collector, and the negative electrode active material layer includes a negative electrode active material, a conductive material, a binder, and the like with a space therebetween. It is preferable that the dripped electrolytes move from the dripping positions to the space in the negative electrode active material layer so that the negative electrode is in a state of being uniformly impregnated with the electrolytes, ideally, in a state without any space. FIG. 1B illustrates dripping of electrolytes 515c on 140 portions (7 columns×20 rows) at regular intervals on the negative electrode; however, one embodiment of the present invention is not particularly limited thereto, and the details of dripping are determined as appropriate by a practitioner. In the case of using one nozzle, scanning is sequentially performed while the dripping positions are checked with a CCD or the like, and it is preferable that drops be dripped from a plurality of nozzles at the same time, in which case the treatment time for dripping can be shortened.

The secondary battery of one embodiment of the present invention can be fabricated in the following manner: a plurality of drops of the electrolyte are dripped on any one or more of the positive electrode, the negative electrode, and the separator for uniform impregnation; the stack 512 of the positive electrode, the separator, and the negative electrode is sandwiched by an exterior film to be the exterior body; and then outer edges (four sides when seen from above, in the case where the exterior of the secondary battery is a thin rectangular solid) are sealed without any space. For example, the outer edges of a seal region 513 illustrated in FIG. 1B are sealed. Sealing can also be performed under atmospheric pressure; in that case, the sealing is performed under an inert atmosphere of an argon gas, a nitrogen gas, or the like. The sealing is preferably performed under reduced pressure, in which case an impurity or the air hardly enters a hermetically sealed region surrounded by the exterior film. In this embodiment, the sealing is performed in a chamber with a pressure of approximately 4×10⁴ Pa.

As illustrated in FIG. 1C, multiple formation can be performed by arranging a plurality of stacks 512 on the exterior film. Multiple formation refers to a method for fabricating a plurality of secondary batteries, in which a plurality of stacks are arranged on one large exterior film to form secondary batteries, and then, the exterior film is planarly divided for each stack. Multiple formation can shorten the fabrication time per secondary battery.

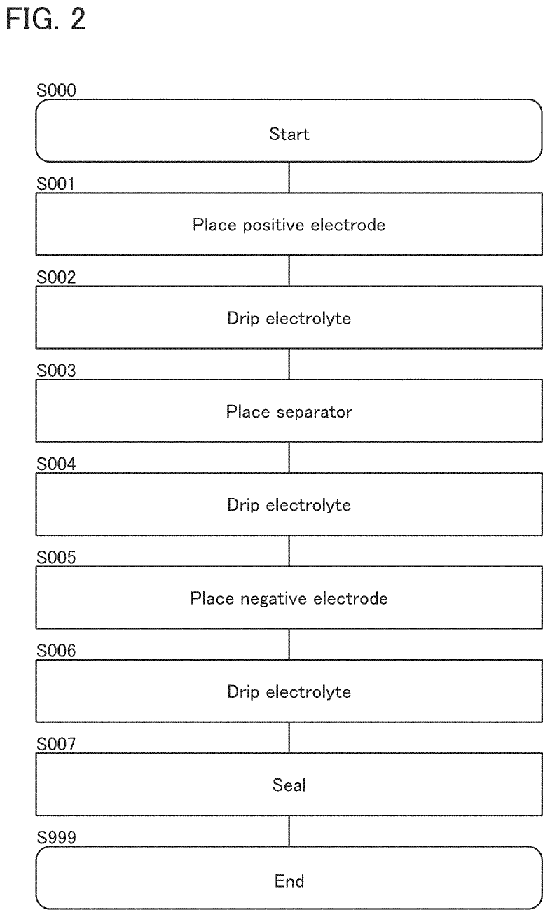

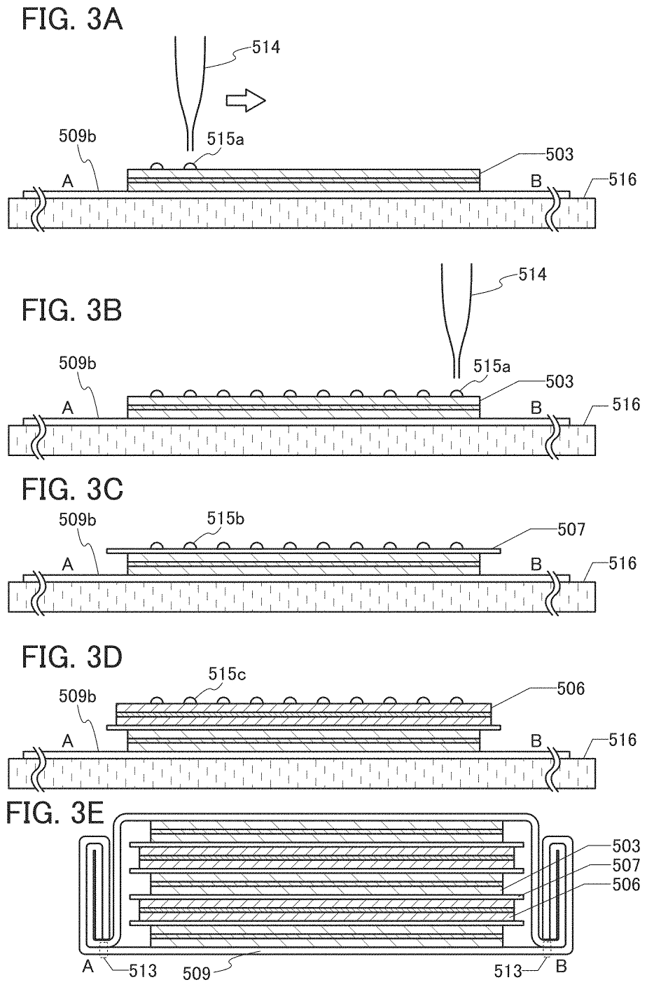

FIG. 2 is a flow chart showing a method for fabricating the secondary battery of one embodiment of the present invention. FIG. 3 is a cross-sectional view illustrating the method for fabricating the secondary battery of one embodiment of the present invention, and corresponds to the dashed-double dotted line A-B shown in FIG. 1C.

An example of the method for fabricating the secondary battery of one embodiment of the present invention will be described with reference to the flow chart shown in FIG. 2.

In Step S000, processing starts.

In Step S001, the positive electrode is placed. The positive electrode is placed over an exterior film 509b to be the exterior body 509. The exterior film 509b is placed over a stage 516. Although the positive electrode, the exterior film, and the stage are each placed in the chamber, the inner walls and the like of the chamber are not illustrated here for simplicity.

Next, the electrolyte is dripped in Step S002. FIG. 3A illustrates a state where the positive electrode 503 is placed over the exterior film 509b and an electrolyte 515a is dripped from a nozzle 514. With the movement of the nozzle 514, the electrolyte 515a can be dripped on the entire surface of the positive electrode 503 as illustrated in FIG. 3B. Alternatively, the electrolyte 515a may be dripped on the entire surface of the positive electrode 503 with the movement of the stage 516.

Next, the separator 507 is placed over the positive electrode 503 to overlap with the positive electrode 503 in Step S003. Next, an electrolyte 515b is dripped on the separator 507 in Step S004. FIG. 3C illustrates a state where the electrolyte 515b is dripped on the separator.

Next, the negative electrode is placed over the positive electrode 503 and the separator 507 to overlap with the positive electrode 503 and the separator 507 in Step S005. Next, the electrolyte 515c is dripped in Step S006. FIG. 3D illustrates a state where the electrolyte 515c is dripped on the negative electrode.

After Step S006, another stack of a positive electrode, a separator, and a negative electrode can be further stacked. For example, after Step S006, a separator, a positive electrode, a separator, a negative electrode, a separator, and a positive electrode are stacked in this order, whereby the stack 512 illustrated in FIG. 1A can be fabricated. It is preferable to drip the electrolyte after the positive electrode, the negative electrode, and the separator are placed.

Note that in the steps of placing the positive electrode, the negative electrode, and the separator, the electrolyte is not necessarily dripped in some cases. For example, the electrolyte may be dripped only in the steps of placing the positive electrode and the negative electrode. For another example, the electrolyte may be dripped only in the step of placing the separator.

Next, the exterior film 509b is sealed under reduced pressure in Step S007. FIG. 3E illustrates a state where the exterior film 509b is sealed.

Through the above steps, the processing ends in Step S008.

### Embodiment 2

In this embodiment, examples of the secondary battery of one embodiment of the present invention will be described.

### <Structure Example 1 of Secondary Battery>

Hereinafter, a secondary battery in which a positive electrode, a negative electrode, and an electrolyte solution are wrapped in an exterior body is described as an example.

### [Positive Electrode]

The positive electrode includes a positive electrode active material layer and a positive electrode current collector. The positive electrode active material layer includes a positive electrode active material, and may include the above-described conductive material and a binder.

### [Negative Electrode]

The negative electrode includes a negative electrode active material layer and a negative electrode current collector. The negative electrode active material layer includes a negative electrode active material, and may include the above-described conductive material and the above-described binder.

### [Current Collector]

For each of the positive electrode current collector and the negative electrode current collector, it is possible to use a highly conductive material that is not alloyed with carrier ions of lithium or the like, e.g., a metal such as stainless steel, gold, platinum, zinc, iron, copper, aluminum, or titanium, an alloy thereof, or the like. The current collector can have a sheet-like shape, a net-like shape, a punching-metal shape, an expanded-metal shape, or the like as appropriate. The current collector preferably has a thickness greater than or equal to 10 μm and less than or equal to 30 μm.

Note that a material that is not alloyed with carrier ions of lithium or the like is preferably used for the negative electrode current collector.

As the current collector, a titanium compound may be stacked over the above-described metal. As a titanium compound, for example, it is possible to use one selected from titanium nitride, titanium oxide, titanium nitride in which oxygen is substituted for part of nitrogen, titanium oxide in which nitrogen is substituted for part of oxygen, and titanium oxynitride (TiOₓN_{y}, where 0<x<2 and 0<y<1), or a mixture or a stack of two or more of them. Titanium nitride is particularly preferable because it has high conductivity and has a high capability of inhibiting oxidation. Provision of a titanium compound over the surface of the current collector inhibits a reaction between a material contained in the active material layer formed over the current collector and the metal, for example. In the case where the active material layer contains a compound containing oxygen, an oxidation reaction between the metal element and oxygen can be inhibited. In the case where aluminum is used for the current collector and the active material layer is formed using graphene oxide described later, for example, an oxidation reaction between oxygen contained in the graphene oxide and aluminum might occur. In such a case, provision of a titanium compound over aluminum can inhibit an oxidation reaction between the current collector and the graphene oxide.

An active material layer such as the positive electrode active material layer or the negative electrode active material layer preferably contains a conductive material. It is preferable to contain a carbon-based material such as a graphene compound, carbon black, graphite, carbon fiber, or fullerene as the conductive material, and it is particularly preferable to contain a graphene compound. As the carbon black, acetylene black (AB) can be used, for example. As the graphite, natural graphite or artificial graphite such as mesocarbon microbeads can be used, for example. Note that these carbon-based materials may each function as an active material.

As carbon fiber, mesophase pitch-based carbon fiber and isotropic pitch-based carbon fiber can be used, for example. As the carbon fiber, carbon nanofiber, carbon nanotube, or the like can be used. Carbon nanotube can be formed by, for example, a vapor deposition method.

The active material layer may contain as a conductive material metal powder or metal fiber of copper, nickel, aluminum, silver, gold, or the like, a conductive ceramic material, or the like.

The content of the conductive material to the total amount of the active material layer is preferably greater than or equal to 1 wt % and less than or equal to 10 wt %, further preferably greater than or equal to 1 wt % and less than or equal to 5 wt %.

Unlike a particulate conductive material such as carbon black, which makes point contact with an active material, the graphene compound is capable of making low-resistance surface contact; accordingly, the electrical conduction between the particulate active material and the graphene compound can be improved with a smaller amount of the graphene compound than that of a normal conductive material. This can increase the proportion of the active material in the active material layer. Thus, discharge capacity of the secondary battery can be increased.

A compound containing particulate carbon such as carbon black or graphite or a compound containing fibrous carbon such as carbon nanotube easily enters a microscopic space. A microscopic space refers to, for example, a region between a plurality of active materials. When a carbon-containing compound that easily enters a microscopic space and a compound containing sheet-like carbon, such as graphene, that can impart conductivity to a plurality of particles are used in combination, the density of the electrode increases and an excellent conductive path can be formed. The secondary battery obtained by the fabrication method of one embodiment of the present invention can have stability, and is effective as an in-vehicle secondary battery. An increase in the number of secondary batteries results in complicated control. With the use of a large secondary battery, the number of secondary batteries can be reduced and a load on a charge control circuit can be reduced.

The active material layer preferably includes a binder (not illustrated). The binder binds or fixes the electrolyte and the active material, for example. In addition, the binder can bind or fix the electrolyte and a carbon-based material, the active material and a carbon-based material, a plurality of active materials, a plurality of carbon-based materials, or the like.

As the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

Polyimide has thermally, mechanically, and chemically excellent stable properties.

A fluorine polymer which is a high molecular material containing fluorine, specifically, polyvinylidene fluoride (PVDF) or the like can be used. PVDF is a resin having a melting point in the range of higher than or equal to 134° C. and lower than or equal to 169° C., and is a material with excellent thermal stability.

As the binder, a rubber material such as styrene-butadiene rubber (SBR), styrene-isoprene-styrene rubber, acrylonitrile-butadiene rubber, butadiene rubber, or an ethylene-propylene-diene copolymer is preferably used. Alternatively, fluororubber can be used as the binder.

As the binder, for example, water-soluble polymers are preferably used. As the water-soluble polymers, a polysaccharide can be used, for example. As the polysaccharide, starch, a cellulose derivative such as carboxymethyl cellulose (CMC), methyl cellulose, ethyl cellulose, hydroxypropyl cellulose, diacetyl cellulose, or regenerated cellulose, or the like can be used. It is further preferred that such water-soluble polymers be used in combination with any of the above-described rubber materials.

Two or more of the above materials may be used in combination for the binder.

### <Graphene Compound>

A graphene compound in this specification and the like refers to graphene, multilayer graphene, multi graphene, graphene oxide, multilayer graphene oxide, multi graphene oxide, reduced graphene oxide, reduced multilayer graphene oxide, reduced multi graphene oxide, graphene quantum dots, and the like. A graphene compound contains carbon, has a plate-like shape, a sheet-like shape, or the like, and has a two-dimensional structure formed of a six-membered ring composed of carbon atoms. The two-dimensional structure formed of the six-membered ring composed of carbon atoms may be referred to as a carbon sheet. A graphene compound may include a functional group. The graphene compound is preferably bent. A graphene compound may be rounded like carbon nanofiber.

In this specification and the like, for example, graphene oxide contains carbon and oxygen, has a sheet-like shape, and includes a functional group, in particular, an epoxy group, a carboxy group, or a hydroxy group.

In this specification and the like, for example, reduced graphene oxide contains carbon and oxygen, has a sheet-like shape, and has a two-dimensional structure formed of a six-membered ring composed of carbon atoms. The reduced graphene oxide may also be referred to as a carbon sheet. The reduced graphene oxide functions by itself and may have a stacked-layer structure. The reduced graphene oxide preferably includes a portion where the carbon concentration is higher than 80 atomic % and the oxygen concentration is higher than or equal to 2 atomic % and lower than or equal to 15 atomic %. With such a carbon concentration and such an oxygen concentration, the reduced graphene oxide can function as a conductive material with high conductivity even with a small amount. In addition, the intensity ratio G/D of a G band to a D band of the Raman spectrum of the reduced graphene oxide is preferably 1 or more. The reduced graphene oxide with such an intensity ratio can function as a conductive material with high conductivity even with a small amount.

A graphene compound can sometimes be provided with pores by reduction of graphene oxide.

A material obtained by terminating an end portion of graphene with fluorine may be used.

In the longitudinal cross section of the active material layer, the sheet-like graphene compounds are dispersed substantially uniformly in a region inside the active material layer. The plurality of graphene compounds are formed to partly coat a plurality of particles of the active material or adhere to the surfaces of the plurality of particles of the active material, so that the graphene compounds make surface contact with the particles of the active material.

Here, the plurality of graphene compounds can be bonded to each other to form a net-like graphene compound sheet (hereinafter, referred to as a graphene compound net or a graphene net). A graphene net that covers the active material can function as a binder for bonding the active materials. Accordingly, the amount of the binder can be reduced, or the binder does not have to be used. This can increase the proportion of the active material in the electrode volume or the electrode weight. That is, the charge and discharge capacity of the secondary battery can be increased.

Here, it is preferable to perform reduction after a layer to be the active material layer is formed in such a manner that graphene oxide is used as the graphene compound and mixed with an active material. That is, the formed active material layer preferably contains reduced graphene oxide. When graphene oxide with extremely high dispersibility in a polar solvent is used to form the graphene compounds, the graphene compounds can be substantially uniformly dispersed in a region inside the active material layer. The solvent is removed by volatilization from a dispersion medium containing the uniformly dispersed graphene oxide to reduce the graphene oxide; hence, the graphene compounds remaining in the active material layer partly overlap with each other and are dispersed such that surface contact is made, thereby forming a three-dimensional conductive path. Note that graphene oxide may be reduced by heat treatment or with the use of a reducing agent, for example.

It is possible to form, with a spray dry apparatus, a graphene compound serving as a conductive material as a coating film to cover the entire surface of the active material in advance and to form a conductive path by electrically connecting the active materials using the graphene compound.

A material used in formation of the graphene compound may be mixed with the graphene compound to be used for the active material layer. For example, particles used as a catalyst in formation of the graphene compound may be mixed with the graphene compound. As an example of the catalyst in formation of the graphene compound, particles containing any of silicon oxide (SiO₂ or SiOₓ (x<2)), aluminum oxide, iron, nickel, ruthenium, iridium, platinum, copper, germanium, and the like can be given. The D50 of the particles is preferably less than or equal to 1 μm, further preferably less than or equal to 100 nm.

### <Example of Negative Electrode Active Material>

As the negative electrode active material, a material that can react with carrier ions of the secondary battery, a material into and from which carrier ions can be inserted and extracted, a material that enables an alloying reaction with a metal serving as a carrier ion, a material that enables melting and precipitation of a metal serving as a carrier ion, or the like is preferably used.

Examples of the negative electrode active material will be described below.

A metal or a compound including one or more elements selected from silicon, tin, gallium, aluminum, germanium, lead, antimony, bismuth, silver, zinc, cadmium, and indium can be used as the negative electrode active material. Examples of an alloy-based compound using such elements include Mg₂Si, Mg₂Ge, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn.

A material whose resistance is lowered by addition of an impurity element such as phosphorus, arsenic, boron, aluminum, or gallium to silicon may be used. Furthermore, a silicon material pre-doped with lithium may be used. Examples of a pre-doping method include annealing of a mixture of silicon with lithium fluoride, lithium carbonate, or the like and mechanical alloying of a lithium metal and silicon. A secondary battery may be fabricated in the following manner: an electrode is formed; lithium doping is performed through charge and discharge reaction with a combination of the formed electrode and an electrode of a lithium metal or the like; and then the electrode subjected to doping is combined with a counter electrode (e.g., a positive electrode for a negative electrode subjected to pre-doping).

For example, silicon nanoparticles can be used as the negative electrode active material. The average diameter of silicon nanoparticles is, for example, preferably greater than or equal to nm and less than 1 μm, further preferably greater than or equal to 10 nm and less than or equal to 300 nm, still further preferably greater than or equal to 10 nm and less than or equal to 100 nm.

The silicon nanoparticles may have crystallinity. The silicon nanoparticles may include a region with crystallinity and an amorphous region.

As a material containing silicon, a material represented by SiOₓ (x is preferably less than 2, further preferably greater than or equal to 0.5 and less than or equal to 1.6) can be used, for example.

Carbon-based materials such as graphite, graphitizing carbon, non-graphitizing carbon, carbon nanotube, carbon black, and a graphene compound can be used as the negative electrode active material, for example.

Furthermore, an oxide including one or more elements selected from titanium, niobium, tungsten, and molybdenum can be used as the negative electrode active material, for example.

As the negative electrode active material, it is possible to use a combination of two or more of the aforementioned metals, materials, compounds, and the like.

As the negative electrode active material, an oxide such as SnO, SnO₂, titanium dioxide (TiO₂), lithium titanium oxide (Li₄Ti₅O₁₂), a lithium-graphite intercalation compound (LixC₆), niobium pentoxide (Nb₂O₅), tungsten oxide (WO₂), or molybdenum oxide (MoO₂) can be used, for example.

Alternatively, as the negative electrode active material, Li₃₋ₓMₓN (M is Co, Ni, or Cu) with a Li₃N structure, which is a composite nitride containing lithium and a transition metal, can be used. For example, Li_{2.6}Co_{0.4}N₃ is preferable because of high charge and discharge capacity (900 mAh/g).

A composite nitride of lithium and a transition metal is preferably used as a negative electrode material, in which case the negative electrode material can be used in combination with a material that does not contain lithium ions, such as V₂O₅ or Cr₃O₈, as a positive electrode material. Note that in the case of using a material containing lithium ions as a positive electrode material, the composite nitride of lithium and a transition metal can be used as the negative electrode material by extracting the lithium ions contained in the positive electrode material in advance.

Alternatively, a material that causes a conversion reaction can be used as the negative electrode active material. For example, a transition metal oxide that does not cause an alloying reaction with lithium, such as cobalt oxide (CoO), nickel oxide (NiO), and iron oxide (FeO), may be used as the negative electrode active material. A conversion reaction also occurs in oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃. Note that any of the fluorides may be used as the positive electrode material because of its high potential.

### <Example of Positive Electrode Active Material>

Examples of the positive electrode active material include lithium-containing materials with an olivine crystal structure, a layered rock-salt crystal structure, and a spinel crystal structure.

As the positive electrode active material of one embodiment of the present invention, a positive electrode active material with a layered crystal structure is preferably used.

An example of a layered crystal structure is a layered rock-salt crystal structure. As a lithium-containing material with a layered rock-salt crystal structure, for example, it is possible to use a lithium-containing material represented by LiMₓO_{y} (x>0 and y>0, more specifically, y=2 and 0.8<x<1.2, for example). Here, M represents a metal element, which is preferably one or more selected from cobalt, manganese, nickel, and iron. Alternatively, M represents two or more selected from cobalt, manganese, nickel, iron, aluminum, titanium, zirconium, lanthanum, copper, and zinc, for example.

Examples of the lithium-containing material represented by LiMₓO_{y} include LiCoO₂, LiNiO₂, and LiMnO₂. Other examples of the lithium-containing material represented by LiMₓO_{y} include a NiCo-based material represented by LiNiₓCo₁₋ₓO₂ (0<x<1) and a NiMn-based material represented by LiNiₓMn₁₋ₓO₂ (0<x<1).

As a lithium-containing material represented by LiMO₂, for example, a NiCoMn-based material (also referred to as NCM) represented by LiNiₓCo_{y}Mn_{z}O₂ (x>0, y>0, and 0.8<x+y+z<1.2) is given. Specifically, 0.1x<y<8x and 0.1x<z<8x are preferably satisfied, for example. For example, x, y, and z preferably satisfy x:y:z=1:1:1 or the neighborhood thereof. Alternatively, for example, x, y, and z preferably satisfy x:y:z=5:2:3 or the neighborhood thereof. Alternatively, for example, x, y, and z preferably satisfy x:y:z=8:1:1 or the neighborhood thereof. Alternatively, for example, x, y, and z preferably satisfy x:y:z=6:2:2 or the neighborhood thereof. Alternatively, for example, x, y, and z preferably satisfy x:y:z=1:4:1 or the neighborhood thereof.

Examples of a lithium-containing material with a layered rock-salt crystal structure include Li₂MnO₃ and Li₂MnO₃—LiMeO₂ (Me represents Co, Ni, or Mn).

With a positive electrode active material having a layered crystal structure typified by the above-described lithium-containing material, a secondary battery with a high lithium content per volume and high capacity per volume can be achieved in some cases. In such a positive electrode active material, the amount of lithium extracted during charge per volume is large; thus, in order to perform stable charge and discharge, a crystal structure after the extraction needs to be stabilized. Collapse of the crystal structure in charge and discharge may hinder fast charge or fast discharge.

As the positive electrode active material, it is preferable to mix lithium nickel oxide (LiNiO₂ or LiNi₁₋ₓMₓO₂ (0<x<1) (M=Co, Al, or the like)) with a lithium-containing material that has a spinel crystal structure and contains manganese, such as LiMn₂O₄. This composition can improve the performance of the secondary battery.

As the positive electrode active material, a lithium-manganese composite oxide that can be represented by a composition formula LiₐMn_{b}M_{c}O_{d} can be used. Here, the element M is preferably silicon, phosphorus, or a metal element other than lithium and manganese, further preferably nickel. In the case where the whole particles of a lithium-manganese composite oxide are measured, it is preferable to satisfy the following at the time of discharging: 0<a/(b+c)<2; c>0; and 0.26 (b+c)/d<0.5. Note that the proportions of metals, silicon, phosphorus, and the like in the whole particles of a lithium-manganese composite oxide can be measured with, for example, an ICP-MS (inductively coupled plasma mass spectrometer). The proportion of oxygen in the whole particles of a lithium-manganese composite oxide can be measured by, for example, EDX (energy dispersive X-ray spectroscopy). Alternatively, the proportion can be measured by ICP-MS analysis combined with fusion gas analysis and valence evaluation of XAFS (X-ray absorption fine structure) analysis. Note that the lithium-manganese composite oxide is an oxide containing at least lithium and manganese, and may contain at least one element selected from a group consisting of chromium, cobalt, aluminum, nickel, iron, magnesium, molybdenum, zinc, indium, gallium, copper, titanium, niobium, silicon, phosphorus, and the like.

### [Structure of Positive Electrode Active Material]

A material with a layered rock-salt crystal structure, such as lithium cobalt oxide (LiCoO₂), is known to have a high discharge capacity and excel as a positive electrode active material of a secondary battery. An example of the material with a layered rock-salt crystal structure is a composite oxide represented by LiMO₂. The metal M contains a metal Me1. The metal Me1 is one or more kinds of metals including cobalt. The metal M can contain a metal X in addition to the metal Me1. The metal X is one or more metals selected from magnesium, calcium, zirconium, lanthanum, barium, copper, potassium, sodium, and zinc.

The remaining amount of lithium that can be inserted into and extracted from a positive electrode active material is represented by x in a compositional formula, e.g., x in LiₓCoO₂ or x in LixMO₂. In this specification, LiₓCoO₂ can be replaced with LixMO₂ as appropriate. In the case of a positive electrode active material in a secondary battery, x can be charge capacity/theoretical capacity. For example, when a secondary battery using LiCoO₂ as a positive electrode active material is charged to 219.2 mAh/g, the positive electrode active material can be represented by Li_{0.8}CoO₂ or x=0.8. Small x in LiₓCoO₂ means, for example, 0.1<x≤0.24.

It is known that the Jahn-Teller effect in a transition metal compound varies in degree according to the number of electrons in the d orbital of the transition metal.

In a compound containing nickel, distortion is likely to be caused because of the Jahn-Teller effect in some cases. Accordingly, when charge and discharge with a high voltage are performed on LiNiO₂, the crystal structure might be broken because of the distortion. The influence of the Jahn-Teller effect is suggested to be small in LiCoO₂; hence, LiCoO₂ is preferable because the resistance to charge and discharge with a high voltage is higher in some cases.

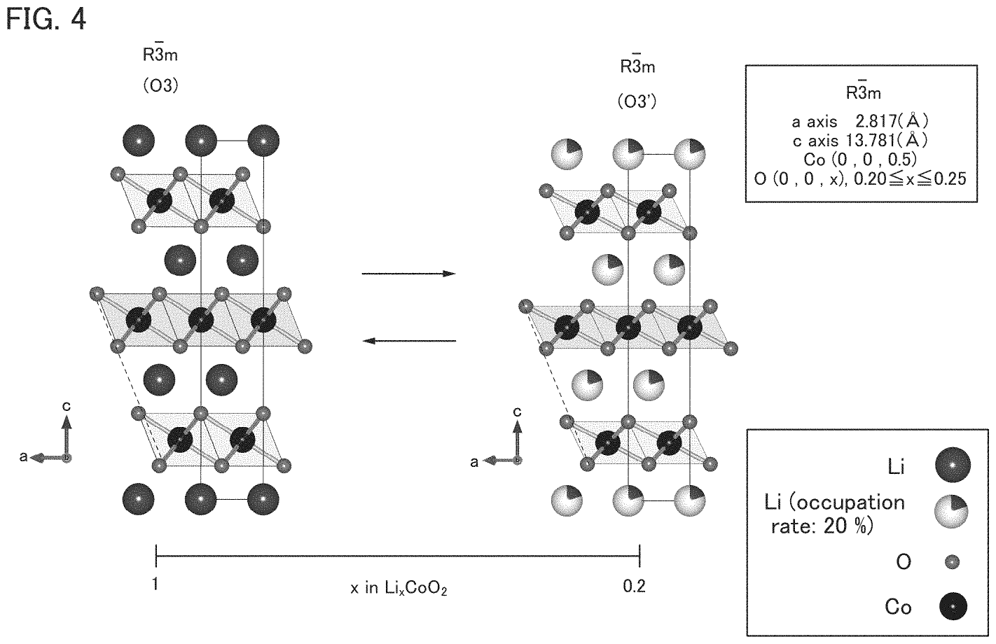

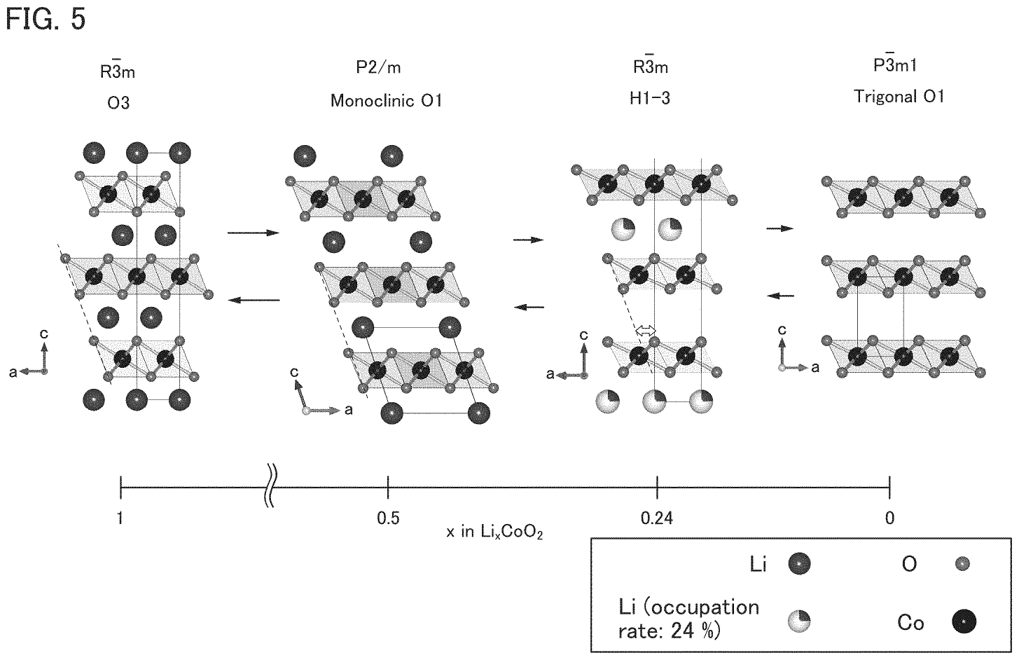

The positive electrode active material will be described with reference to FIG. 4 and FIG. 5.

### <Crystal Structure>

<<x in LiₓCoO₂ Being 1>>

The positive electrode active material of one embodiment of the present invention preferably has a layered rock-salt crystal structure belonging to the space group R-3m in a discharged state, i.e., in the case where x in LiₓCoO₂ is 1. A composite oxide having a layered rock-salt structure excels as a positive electrode active material of a secondary battery because it has high discharge capacity and a two-dimensional diffusion path for lithium ions and is thus suitable for an insertion/extraction reaction of lithium ions. For this reason, it is particularly preferable that an inner portion, which accounts for the majority of the volume of the positive electrode active material, have a layered rock-salt crystal structure. In FIG. 4, the layered rock-salt crystal structure is denoted by R-3m O3.

A surface portion is a region from which lithium ions are extracted first in charge, and is a region that tends to have a lower lithium concentration than the inner portion. Bonds between atoms are regarded as being partly cut on the surface of the positive electrode active material included in the surface portion. Thus, the surface portion is regarded as a region that tends to be unstable and tends to start deterioration of the crystal structure. Meanwhile, when the surface portion can be made sufficiently stable, the layered structure, which is formed of octahedrons of a transition metal M and oxygen, of the inner portion is unlikely to be broken even with small x in LiₓCoO₂, e.g., with x of less than or equal to 0.24. Furthermore, a shift in layers, which are formed of octahedrons of the transition metal M and oxygen, of the inner portion can be inhibited.

In order that the surface portion can have a stable composition and a stable crystal structure, the surface portion preferably contains an additive element A, further preferably contains a plurality of additive elements A. The surface portion preferably has a higher concentration of one or more selected from the additive elements A than the inner portion. The one or more selected from the additive elements A contained in the positive electrode active material preferably have a concentration gradient. In addition, it is further preferable that the additive elements A in the positive electrode active material be differently distributed. For example, it is further preferable that the additive elements A exhibit concentration peaks at different depths from a surface. The concentration peak here refers to the local maximum value of the concentration in the surface portion or the concentration in 50 nm or less in depth from the surface.

For example, some of the additive elements A such as magnesium, fluorine, titanium, silicon, phosphorus, boron, and calcium preferably have a concentration gradient in which the concentration increases from the inner portion toward the surface. An element having such a concentration gradient is referred to as an additive element X.

For example, magnesium, which is one of the additive elements X, is divalent, and a magnesium ion is more stable in lithium sites than in transition metal M sites in the layered rock-salt crystal structure and thus is likely to enter the lithium sites. An appropriate concentration of magnesium in the lithium sites of the surface portion facilitates maintenance of the layered rock-salt crystal structure. This is probably because magnesium in the lithium sites serves as a column supporting the CoO₂ layers. Moreover, the presence of magnesium can inhibit extraction of oxygen around magnesium in a state where x in LiₓCoO₂ is, for example, less than or equal to 0.24. The presence of magnesium probably increases the density of the positive electrode active material. In addition, a high magnesium concentration in the surface portion probably increases the corrosion resistance to hydrofluoric acid generated by the decomposition of the electrolyte solution.

An appropriate concentration of magnesium does not have an adverse effect on insertion or extraction of lithium in charge and discharge, and the above-described advantages can be obtained. However, excess magnesium might adversely affect insertion and extraction of lithium. Furthermore, the effect of stabilizing the crystal structure might be reduced. This is probably because magnesium enters the transition metal M sites in addition to the lithium sites. Moreover, an undesired magnesium compound (e.g., an oxide or a fluoride) which is substituted for neither the lithium site nor the transition metal M site might segregate at the surface of the positive electrode active material or the like to serve as a resistance component of a secondary battery. As the magnesium concentration in the positive electrode active material increases, the discharge capacity of the positive electrode active material decreases in some cases. This is probably because excess magnesium enters the lithium sites and the amount of lithium contributing to charge and discharge decreases.

Thus, the entire positive electrode active material preferably contains an appropriate amount of magnesium. For example, the number of magnesium atoms is preferably greater than or equal to 0.001 times and less than or equal to 0.1 times, further preferably greater than 0.01 times and less than 0.04 times, still further preferably approximately 0.02 times the number of cobalt atoms. The amount of magnesium contained in the entire positive electrode active material here may be a value obtained by element analysis on the entire positive electrode active material using GD-MS, ICP-MS, or the like, or may be a value based on the ratio of the raw materials mixed in the formation process of the positive electrode active material, for example.

Aluminum, which is one of additive elements Y, can exist in a transition metal M site in a layered rock-salt crystal structure. Since aluminum is a trivalent representative element and its valence does not change, lithium around aluminum is unlikely to move even in charge and discharge. Thus, aluminum and lithium therearound serve as columns to inhibit a change in the crystal structure. Furthermore, aluminum has effects of inhibiting elution of the transition metal M around aluminum and improving continuous charge tolerance. Moreover, an Al—O bond is stronger than a Co—O bond; thus, extraction of oxygen around aluminum can be inhibited. These effects improve thermal stability. Hence, a secondary battery containing aluminum as the additive element Y can have improved stability. Furthermore, the positive electrode active material can have a crystal structure that is unlikely to be broken by repeated charge and discharge.

Meanwhile, excess aluminum might adversely affect insertion and extraction of lithium.

Thus, the entire positive electrode active material preferably contains an appropriate amount of aluminum. For example, the number of aluminum atoms contained in the entire positive electrode active material is preferably greater than or equal to 0.05% and less than or equal to 4%, further preferably greater than or equal to 0.1% and less than or equal to 2%, still further preferably greater than or equal to 0.3% and less than or equal to 1.5% of the number of cobalt atoms. Alternatively, the number of aluminum atoms is preferably greater than or equal to 0.05% and less than or equal to 2% of the number of cobalt atoms. Alternatively, the number of aluminum atoms is preferably greater than or equal to 0.1% and less than or equal to 4% of the number of cobalt atoms. The amount contained in the entire positive electrode active material here may be a value obtained by element analysis on the entire positive electrode active material using GD-MS, ICP-MS, or the like, or may be a value based on the ratio of the raw materials mixed in the formation process of the positive electrode active material, for example.

For example, a crystal structure preferably changes continuously from the layered rock-salt inner portion toward the surface and the surface portion that have a rock-salt structure or have features of both a rock-salt structure and a layered rock-salt structure. Alternatively, the orientations of the surface portion that has a rock-salt structure or has the features of both a rock-salt structure and a layered rock-salt structure and the layered rock-salt inner portion are preferably substantially aligned with each other.

In this specification and the like, a layered rock-salt crystal structure, which belongs to the space group R-3m, of a composite oxide containing lithium and the transition metal M such as cobalt refers to a crystal structure in which a rock-salt ion arrangement where cations and anions are alternately arranged is included and lithium and the transition metal M are regularly arranged to form a two-dimensional plane, so that lithium can be diffused two-dimensionally. Note that a defect such as a cation or anion vacancy may exist. In the layered rock-salt crystal structure, strictly, a lattice of a rock-salt crystal is distorted in some cases.

A rock-salt crystal structure refers to a structure in which a cubic crystal structure with the space group Fm-3m or the like is included and cations and anions are alternately arranged. Note that a cation or anion vacancy may exist.

Having features of both a layered rock-salt crystal structure and a rock-salt crystal structure can be judged by electron diffraction, a TEM image, a cross-sectional STEM image, and the like.

Anions of a layered rock-salt crystal and anions of a rock-salt crystal have a cubic close-packed structure (face-centered cubic lattice structure). Anions of an O3′ type crystal (also referred to as a pseudo-spinel crystal) described later are also presumed to have a cubic close-packed structure. Thus, when a layered rock-salt crystal and a rock-salt crystal are in contact with each other, there is a crystal plane at which orientations of cubic close-packed structures composed of anions are aligned with each other.

The description can also be made as follows. Anions on the {111} plane of a cubic crystal structure have a triangle lattice. A layered rock-salt structure, which belongs to a space group R-3m and is a rhombohedral structure, is generally represented by a composite hexagonal lattice for easy understanding of the structure, and the (0001) plane of the layered rock-salt structure has a hexagonal lattice. The triangle lattice on the {111} plane of the cubic crystal has atomic arrangement similar to that of the hexagonal lattice on the (0001) plane of the layered rock-salt structure. These lattices being consistent with each other can be expressed as “orientations of the cubic close-packed structures are aligned with each other.”

Note that the space groups of the layered rock-salt crystal and the O3′ type crystal are R-3m, which is different from the space group Fm-3m (the space group of a general rock-salt crystal) of the rock-salt crystal; thus, the Miller index of the crystal plane satisfying the above conditions in the layered rock-salt crystal and the O3′ type crystal is different from that in the rock-salt crystal. In this specification, a state where the orientations of the cubic close-packed structures composed of anions in the layered rock-salt crystal, the O3′ type crystal, and the rock-salt crystal are aligned with each other is referred to as a state where crystal orientations are substantially aligned with each other in some cases.

The orientations of crystals in two regions being substantially aligned with each other can be judged, for example, from a TEM (Transmission Electron Microscope) image, a STEM (Scanning Transmission Electron microscope) image, a HAADF-STEM (High-angle Annular Dark Field Scanning TEM) image, an ABF-STEM (Annular Bright-Field Scanning Transmission Electron microscopy) image, electron diffraction, and FFT of a TEM image, a STEM image, and the like. XRD (X-ray Diffraction), neutron diffraction, and the like can also be used for judging.

In FIG. 5, the crystal structure of lithium cobalt oxide with x in LiₓCoO₂ of 1 is denoted by R-3m O3. In this crystal structure, lithium occupies octahedral sites and a unit cell includes three CoO₂ layers. Thus, this crystal structure is referred to as an O3 type crystal structure in some cases. Note that the CoO₂ layer has a structure in which octahedral geometry with oxygen hexacoordinated to cobalt continues on a plane in the edge-sharing state. This is sometimes referred to as a layer formed of octahedrons of cobalt and oxygen.

Conventional lithium cobalt oxide with x of approximately 0.5 is known to have an improved symmetry of lithium and have a monoclinic crystal structure belonging to the space group P2/m. This structure includes one CoO₂ layer in a unit cell. Thus, this crystal structure is referred to as an O1 type structure or a monoclinic O1 type structure in some cases.

When x is 0, the positive electrode active material has a trigonal crystal structure of the space group P-3m1, and one CoO₂ layer exists in a unit cell. Thus, this crystal structure is referred to as an O1 type structure or a trigonal O1 type structure in some cases. Moreover, in some cases, this crystal structure is referred to as a hexagonal O1 type structure when a trigonal crystal is converted into a composite hexagonal lattice.

When x is approximately 0.24, conventional lithium cobalt oxide has the crystal structure of the space group R-3m. This structure is also regarded as a structure in which CoO₂ structures such as trigonal O1 type structures and LiCoO₂ structures such as R-3m O3 are alternately stacked. Thus, this crystal structure is referred to as an H1-3 type crystal structure in some cases. Note that the number of cobalt atoms per unit cell in the actual H1-3 type crystal structure is twice as large as that of cobalt atoms per unit cell in other structures. However, in this specification including FIG. 5, the c-axis of the H1-3 type crystal structure is half that of the unit cell for easy comparison with the other crystal structures.

As denoted by the dotted lines in FIG. 4, the CoO₂ layers hardly shift between the R-3m (O3) and the O3′ type crystal structure in a discharged state.

The R-3m (O3) and the O3′ type crystal structure in a discharged state that contain the same number of cobalt atoms have a difference in volume of 2.5% or less, more specifically 2.2% or less, typically 1.8%.

As described above, in the positive electrode active material of one embodiment of the present invention, a change in the crystal structure caused when x in LiₓCoO₂ is small, i.e., when a large amount of lithium is extracted, is smaller than that in a conventional positive electrode active material. In addition, a change in the volume in the case where the positive electrode active materials having the same number of cobalt atoms are compared is inhibited. Thus, the crystal structure of the positive electrode active material is unlikely to be broken even when charge and discharge are repeated so that x becomes less than or equal to 0.24. This inhibits a decrease in charge and discharge capacity of the positive electrode active material in charge and discharge cycles. Furthermore, the positive electrode active material can stably use a larger amount of lithium than a conventional positive electrode active material and thus has high discharge capacity per weight and per volume. Hence, with the use of the positive electrode active material, a secondary battery with high discharge capacity per weight and per volume can be fabricated.

Note that the positive electrode active material is confirmed to have the O3′ type crystal structure in some cases when x in LiₓCoO₂ is greater than or equal to 0.15 and less than or equal to 0.24, and is presumed to have the O3′ type crystal structure even when x is greater than 0.24 and less than or equal to 0.27. However, the crystal structure is influenced not only by x in LiₓCoO₂ but also by the number of charge and discharge cycles, charge and discharge current, temperature, an electrolyte, and the like; thus, the range of x is not limited to the above.

Thus, when x in LiₓCoO₂ is greater than 0.1 and less than or equal to 0.24, the entire internal structure of the positive electrode active material is not necessarily the O3′ type crystal structure. The positive electrode active material either may include another crystal structure or may be partly amorphous.

In order to make x in LiₓCoO₂ small, charge at a high charge voltage is necessary in general. Thus, a state where x in LiₓCoO₂ is small can be rephrased as a state where charge at a high charge voltage has been performed. For example, when CC/CV charge is performed at 25° C. and 4.6 V or higher with reference to the potential of a lithium metal, the H1-3 type crystal structure appears in a conventional positive electrode active material. Hence, a charge voltage of 4.6 V or higher can be regarded as a high charge voltage with reference to the potential of a lithium metal. In this specification and the like, unless otherwise specified, charge voltage is shown with reference to the potential of a lithium metal.

Thus, the positive electrode active material of one embodiment of the present invention is preferable because the crystal structure with the symmetry of R-3m O3 can be maintained even when charge at a high charge voltage of 4.6 V or higher is performed at 25° C., for example. Moreover, the positive electrode active material of one embodiment of the present invention is preferable because the O3′ type crystal structure can be obtained when charge at a higher charge voltage, e.g., a voltage higher than or equal to 4.65 V and lower than or equal to 4.7 V, is performed at 25° C.

At a much higher charge voltage, the H1-3 type crystal is eventually observed also in the positive electrode active material in some cases. As described above, the crystal structure is influenced by the number of charge and discharge cycles, charge and discharge current, an electrolyte, and the like; thus, the positive electrode active material of one embodiment of the present invention sometimes has the O3′ type crystal structure even at a lower charge voltage, e.g., a charge voltage higher than or equal to 4.5 V and lower than 4.6 V, at 25° C.

Note that in the case where graphite is used as a negative electrode active material in a secondary battery, for example, the voltage of the secondary battery is lower than the above-mentioned voltage by the potential of graphite. The potential of graphite is approximately 0.05 V to 0.2 V with reference to the potential of a lithium metal. Thus, in the case of a secondary battery using graphite as a negative electrode active material, a similar crystal structure is obtained at a voltage obtained by subtracting the potential of the graphite from the above-described voltage.

### <Particle Diameter>

A too large particle diameter of the positive electrode active material of one embodiment of the present invention causes problems such as difficulty in lithium diffusion and too much surface roughness of an active material layer in coating to a current collector. By contrast, a too small particle diameter causes problems such as difficulty in carrying an active material layer in coating to a current collector and overreaction with an electrolyte solution. Thus, the median diameter (D50) is preferably greater than or equal to 1 μm and less than or equal to 100 μm, further preferably greater than or equal to 2 μm and less than or equal to 40 μm, still further preferably greater than or equal to 5 μm and less than or equal to 30 μm. Alternatively, the D50 is preferably greater than or equal to 1 μm and less than or equal to 40 μm. Alternatively, the D50 is preferably greater than or equal to 1 μm and less than or equal to 30 μm. Alternatively, the D50 is preferably greater than or equal to 2 μm and less than or equal to 100 μm. Alternatively, the D50 is preferably greater than or equal to 2 μm and less than or equal to 30 μm. Alternatively, the D50 is preferably greater than or equal to 5 μm and less than or equal to 100 μm. Alternatively, the D50 is preferably greater than or equal to 5 μm and less than or equal to 40 μm.

### <Analysis Method>

Whether or not a given positive electrode active material is the positive electrode active material of one embodiment of the present invention, which has the O3′ type crystal structure when x in LiₓCoO₂ is small, can be judged by analyzing a positive electrode including the positive electrode active material with small x in LiₓCoO₂ by XRD, electron diffraction, neutron diffraction, electron spin resonance (ESR), nuclear magnetic resonance (NMR), or the like.

XRD is particularly preferable because the symmetry of the transition metal M such as cobalt contained in the positive electrode active material can be analyzed with high resolution, the degrees of crystallinity and the crystal orientations can be compared, the distortion of lattice periodicity and the crystallite size can be analyzed, and a positive electrode obtained by disassembling a secondary battery can be measured without any change with sufficient accuracy, for example. A diffraction peak reflecting the crystal structure of the inner portion of the positive electrode active material, which accounts for the majority of the volume of the positive electrode active material, is obtained through XRD, in particular, powder XRD.

As described above, the positive electrode active material of one embodiment of the present invention has a feature of a small change in the crystal structure between when x in LiₓCoO₂ is 1 and when x is less than or equal to 0.24. A material where 50% or more of the crystal structure largely changes in high-voltage charge is not preferable because the material cannot withstand high-voltage charge and discharge.

It should be noted that the O3′ type crystal structure is not obtained in some cases only by addition of the additive element A. For example, when x in LiₓCoO₂ is less than or equal to 0.24, lithium cobalt oxide containing magnesium and fluorine or lithium cobalt oxide containing magnesium and aluminum has the O3′ type crystal structure at 60% or more in some cases, and has the H1-3 type crystal structure at 50% or more in other cases, depending on the concentration and distribution of the additive element A.

In addition, in the case where x is too small, e.g., 0.1 or less, or under the condition where charge voltage is higher than 4.9 V, the positive electrode active material of one embodiment of the present invention sometimes has the H1-3 type crystal structure or the trigonal O1 type crystal structure. Thus, determining whether or not a positive electrode active material is the positive electrode active material of one embodiment of the present invention requires analysis of the crystal structure by XRD and other methods and data such as charge capacity or charge voltage.

Note that a positive electrode active material with small x sometimes causes a change in the crystal structure when exposed to the air. For example, the O3′ type crystal structure changes into the H1-3 type crystal structure in some cases. For that reason, all samples subjected to analysis of crystal structures are preferably handled in an inert atmosphere such as an argon atmosphere.

Whether the additive element A contained in a given positive electrode active material has the above-described distribution can be judged by, for example, analysis using XPS, energy dispersive X-ray spectroscopy (EDX), EPMA (electron probe microanalysis), or the like.

The crystal structure of the surface portion, a crystal grain boundary, or the like can be analyzed by electron diffraction of a cross section of the positive electrode active material, for example.

For the H1-3 type crystal structure, the coordinates of cobalt and oxygen in the unit cell can be expressed as follows, for example: Co (0, 0, 0.42150±0.00016), O1 (0, 0, 0.27671±0.00045), and O2 (0, 0, 0.11535±0.00045). O1 and O2 are each an oxygen atom. A unit cell that should be used for representing a crystal structure in a positive electrode active material can be judged by the Rietveld analysis of XRD, for example. In this case, a unit cell is selected such that the value of GOF (goodness of fit) is small.

When charge and discharge are repeated so that x in LiₓCoO₂ becomes less than or equal to 0.24, the crystal structure of conventional lithium cobalt oxide repeatedly changes between the H1-3 type crystal structure and the R-3m O3 structure in the discharged state (i.e., an unbalanced phase change).

However, there is a large shift in the CoO₂ layers between these two crystal structures. As indicated by a dotted line and an arrow in FIG. 5, the CoO₂ layer in the H1-3 type crystal structure largely shifts from that in R-3m O3 in the discharged state. Such a dynamic structural change might adversely affect the stability of the crystal structure.

A difference in volume between these two crystal structures is also large. The difference in volume per the same number of cobalt atoms between the H1-3 type crystal structure and the R-3m O3 type crystal structure in the discharged state is greater than 3.5%, typically greater than or equal to 3.9%.

In addition, a structure in which CoO₂ layers are continuous, such as the trigonal O1 type structure, included in the H1-3 type crystal structure is highly likely to be unstable.

Thus, when charge and discharge are repeated so that x becomes less than or equal to 0.24, the crystal structure of conventional lithium cobalt oxide is gradually broken. The break of the crystal structure degrades the cycle performance. This is because the broken crystal structure has a smaller number of sites where lithium can exist stably and makes it difficult to insert and extract lithium.

### <Electrolyte>

In the case where a liquid electrolyte layer is used for a secondary battery, for example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used for the electrolyte layer, or two or more of them can be used in an appropriate combination at an appropriate ratio.

The electrolyte preferably contains fluorine. As the electrolyte containing fluorine, for example, an electrolyte containing one kind or two or more kinds of fluorinated cyclic carbonates and lithium ions can be used. The fluorinated cyclic carbonate can improve nonflammability and increase the safety of the lithium-ion secondary battery.

As the fluorinated cyclic carbonate, ethylene fluoride carbonate such as monofluoroethylene carbonate (fluoroethylene carbonate, FEC, or F1EC), difluoroethylene carbonate (DFEC or F2EC), trifluoroethylene carbonate (F3EC), or tetrafluoroethylene carbonate (F4EC) can be used, for example. Note that DFEC includes an isomer such as cis-4,5 or trans-4,5. For operation at low temperatures, as the electrolyte, it is important to use one kind or two or more kinds of fluorinated cyclic carbonates to solvate a lithium ion and transport the lithium ion in the electrolyte included in the electrode in charge and discharge. When the fluorinated cyclic carbonate is not used as a small amount of additive but is contributed to transportation of a lithium ion in charge and discharge, operation can be performed at low temperatures. In the secondary battery, a group of approximately several to several tens of lithium ions moves.

The use of the fluorinated cyclic carbonate for the electrolyte can reduce desolvation energy that is necessary for a solvated lithium ion to enter an active material particle in the electrolyte included in an electrode. The reduction in the desolvation energy can facilitate insertion or extraction of a lithium ion into or from the active material particle even in a low-temperature range. Although a lithium ion sometimes moves remaining in a solvated state, a hopping phenomenon in which coordinated solvent molecules are interchanged occurs in some cases. When desolvation of a lithium ion becomes easy, movement owing to the hopping phenomenon is facilitated and the lithium ion may easily move. A decomposition product of the electrolyte generated by charge and discharge of the secondary battery clings to the surface of the active material, which might cause deterioration of the secondary battery. However, since the electrolyte containing fluorine is smooth, the decomposition product of the electrolyte is less likely to attach to the surface of the active material. Thus, the deterioration of the secondary battery can be suppressed.

In some cases, solvated lithium ions form a cluster in the electrolyte and the cluster moves in the negative electrode, between the positive electrode and the negative electrode, or in the positive electrode, for example.

An example of the fluorinated cyclic carbonate is shown below.

The monofluoroethylene carbonate (FEC) is represented by Formula (1) below.

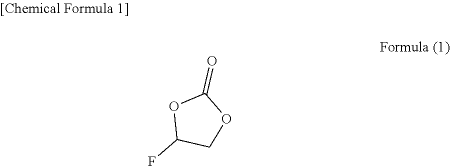

The tetrafluoroethylene carbonate (F4EC) is represented by Formula (2) below.

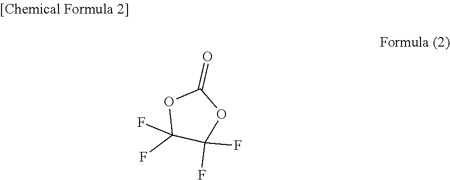

The difluoroethylene carbonate (DFEC) is represented by Formula (3) below.

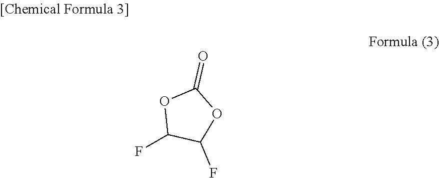

The use of one or more ionic liquids (room temperature molten salts) that are less likely to burn and volatize as the solvent of the electrolyte can prevent a secondary battery from exploding or catching fire even when the secondary battery internally shorts out or the temperature of the internal region increases owing to overcharge or the like. An ionic liquid contains a cation and an anion, specifically, an organic cation and an anion. Examples of the organic cation include aliphatic onium cations such as a quaternary ammonium cation, a tertiary sulfonium cation, and a quaternary phosphonium cation, and aromatic cations such as an imidazolium cation and a pyridinium cation. Examples of the anion include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As an ionic liquid containing imidazolium cations, an ionic liquid represented by General Formula (G1) below can be used, for example. In General Formula (G1), R¹ represents an alkyl group having 1 to 10 carbon atoms, R² to R⁴ each independently represent a hydrogen atom or an alkyl group having 1 to 4 carbon atoms, and R⁵ represents an alkyl group having 1 to 6 carbon atoms or a main chain composed of two or more atoms selected from C, O, Si, N, S, and P atoms. A substituent may be introduced into the main chain represented by R⁵. Examples of the substituent to be introduced include an alkyl group and an alkoxy group.

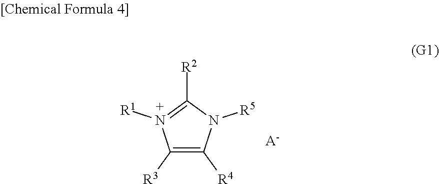

Examples of a cation represented by General Formula (G1) include a 1-ethyl-3-methylimidazolium cation, a 1-butyl-3-methylimidazolium cation, a 1-methyl-3-(propoxyethyl)imidazolium cation, and a 1-hexyl-3-methylimidazolium cation.

As an ionic liquid containing pyridinium cations, an ionic liquid represented by General Formula (G2) below may be used, for example. In General Formula (G2), R⁶ represents an alkyl group having 1 to 6 carbon atoms or a main chain composed of two or more atoms selected from C, O, Si, N, S, and P atoms, and R⁷ to R¹¹ each independently represent a hydrogen atom or an alkyl group having 1 to 4 carbon atoms. A substituent may be introduced into the main chain represented by R⁶. Examples of the substituent to be introduced include an alkyl group and an alkoxy group.

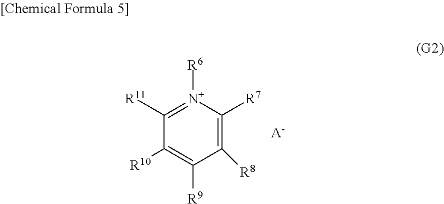

As an ionic liquid containing quaternary ammonium cations, an ionic liquid represented by General Formula (G3), (G4), (G5), or (G6) below can be used, for example.

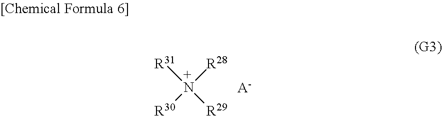

In General Formula (G3), R²⁸ to R³¹ each independently represent an alkyl group, methoxy group, methoxymethyl group, or methoxyethyl group having 1 to 20 carbon atoms, or a hydrogen atom.

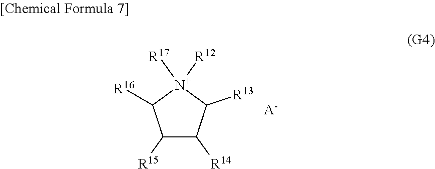

In General Formula (G4), R¹² and R¹⁷ each independently represent an alkyl group having 1 to 3 carbon atoms. R¹³ to R¹⁶ each independently represent any of a hydrogen atom and an alkyl group having 1 to 3 carbon atoms. An example of a cation represented by General Formula (G4) is a 1-methyl-1-propylpyrrolidinium cation.

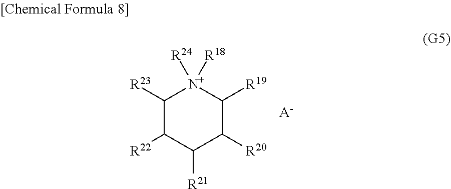

In General Formula (G5), R¹⁸ and R²⁴ each independently represent an alkyl group having 1 to 3 carbon atoms. R¹⁹ to R²³ each independently represent a hydrogen atom or an alkyl group having 1 to 3 carbon atoms. Examples of a cation represented by General Formula (G5) include an N-methyl-N-propylpiperidinium cation and a 1,3-dimethyl-1-propylpiperidinium cation.

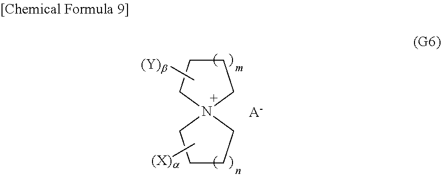

In General Formula (G6), n and m are greater than or equal to 1 and less than or equal to 3. Assume that a is greater than or equal to 0 and less than or equal to 6. When n is 1, a is greater than or equal to 0 and less than or equal to 4. When n is 2, a is greater than or equal to 0 and less than or equal to 5. When n is 3, a is greater than or equal to 0 and less than or equal to 6. Assume that β is greater than or equal to 0 and less than or equal to 6. When m is 1, β is greater than or equal to 0 and less than or equal to 4. When m is 2, β is greater than or equal to 0 and less than or equal to 5. When m is 3, β is greater than or equal to 0 and less than or equal to 6. Note that “α or β is 0” means “unsubstituted”. The case where both a and β are 0 is excluded. X or Y represents a substituent such as a straight-chain or side-chain alkyl group having 1 to 4 carbon atoms, a straight-chain or side-chain alkoxy group having 1 to 4 carbon atoms, or a straight-chain or side-chain alkoxyalkyl group having 1 to 4 carbon atoms.

As an ionic liquid containing tertiary sulfonium cations, an ionic liquid represented by General Formula (G7) below can be used, for example. In General Formula (G7), R²⁵ to R²⁷ each independently represent a hydrogen atom, an alkyl group having 1 to 4 carbon atoms, or a phenyl group. Alternatively, as R²⁵ to R²⁷, a main chain composed of two or more atoms selected from C, O, Si, N, S, and P atoms may be used.

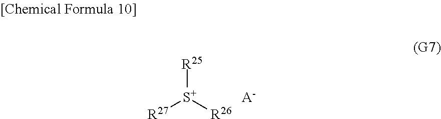

As an ionic liquid containing quaternary phosphonium cations, an ionic liquid represented by General Formula (G8) below can be used, for example. In General Formula (G8), R³² to R³⁵ each independently represent a hydrogen atom, an alkyl group having 1 to 4 carbon atoms, or a phenyl group. Alternatively, as R³² to R³⁵, a main chain composed of two or more atoms selected from C, O, Si, N, S, and P atoms may be used.

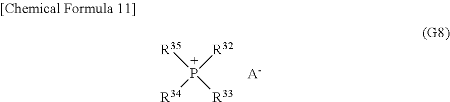

As A⁻ shown in General Formulae (G1) to (G8), one or more of a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion can be used.

As a monovalent amide-based anion, (CₙF₂ₙ₊₁SO₂)₂N⁻ (n=0 to 3) can be used, and as a monovalent cyclic amide-based anion, (CF₂SO₂)₂N⁻ or the like can be used. As a monovalent methide-based anion, (CₙF₂ₙ₊₁SO₂)₃C⁻ (n=0 to 3) can be used, and as a monovalent cyclic methide-based anion, (CF₂SO₂)₂C⁻ (CF₃SO₂) or the like can be used. As a fluoroalkyl sulfonic acid anion, (CₘF₂ₘ₊₁SO₃)⁻ (m=0 to 4) or the like is given. As a fluoroalkylborate anion, {BFₙ(CₘHₖF₂ₘ₊₁₋ₖ)₄₋ₙ}⁻ (n=0 to 3, m=1 to 4, and k=0 to 2m) or the like is given. As a fluoroalkylphosphate anion, {PFₙ(CₘHₖF₂ₘ₊₁₋ₖ)₆₋ₙ} (n=0 to 5, m=1 to 4, and k=0 to 2m) or the like is given.

As a monovalent amide-based anion, one or more of a bis(fluorosulfonyl)amide anion and a bis(trifluoromethanesulfonyl)amide anion can be used, for example.

An ionic liquid may contain one or more of a hexafluorophosphate anion and a tetrafluoroborate anion.

Hereinafter, an anion represented by (FSO₂)₂N⁻ is sometimes represented by an FSA anion, and an anion represented by (CF₃SO₂)₂N⁻ is sometimes represented by a TFSA anion.

The secondary battery of one embodiment of the present invention includes, as a carrier ion, an alkali metal ion such as a sodium ion or a potassium ion or an alkaline earth metal ion such as a calcium ion, a strontium ion, a barium ion, a beryllium ion, or a magnesium ion, for example.

In the case where a lithium ion is used as a carrier ion, for example, an electrolyte contains lithium salt. As the lithium salt, for example, LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂) (CF₃SO₂), or LiN(C₂F₅SO₂)₂ can be used.

In this specification, an electrolyte is a general term of a solid material, a liquid material, a semi-solid-state material, and the like.

Deterioration is likely to occur at an interface existing in a secondary battery, e.g., an interface between an active material and an electrolyte. The secondary battery of one embodiment of the present invention includes the electrolyte containing fluorine, which can prevent deterioration that might occur at an interface between the active material and the electrolyte, typically, alteration of the electrolyte or a higher viscosity of the electrolyte. Alternatively, a structure may be employed in which a binder, a graphene compound, or the like clings to or is held by the electrolyte containing fluorine. This structure can maintain the state where the viscosity of the electrolyte is low, i.e., the state where the electrolyte is smooth, and can improve the reliability of the secondary battery. DFEC to which two fluorine atoms are bonded and F4EC to which four fluorine atoms are bonded have lower viscosities, are smoother, and are coordinated to lithium more weakly than FEC to which one fluorine atom is bonded. Accordingly, it is possible to inhibit attachment of a decomposition product with a high viscosity to an active material particle. When a decomposition product with a high viscosity is attached to or clings to an active material particle, a lithium ion is less likely to move at an interface between active material particles. The solvating fluorine-containing electrolyte reduces generation of a decomposition product that is to be attached to the surface of the active material (the positive electrode active material or the negative electrode active material). Moreover, the use of the electrolyte containing fluorine prevents attachment of a decomposition product, which prevents generation and growth of a dendrite.

The use of the electrolyte containing fluorine as a main component is also a feature, and the amount of the electrolyte containing fluorine is higher than or equal to 5 volume % or higher than or equal to 10 volume %, preferably higher than or equal to 30 volume % and lower than or equal to 100 volume %.

In this specification, a main component of an electrolyte occupies higher than or equal to 5 volume % of the whole electrolyte of a secondary battery. Here, “higher than or equal to 5 volume % of the whole electrolyte of a secondary battery” refers to the proportion in the whole electrolyte that is measured during manufacture of the secondary battery. In the case where a secondary battery is disassembled after manufactured, the proportions of a plurality of kinds of electrolytes are difficult to quantify, but it is possible to judge whether one kind of organic compound occupies higher than or equal to 5 volume % of the whole electrolyte.

With the use of the electrolyte containing fluorine, it is possible to provide a secondary battery that can operate in a wide temperature range, specifically, higher than or equal to −40° C. and lower than or equal to 150° C., preferably higher than or equal to −40° C. and lower than or equal to 85° C.

An additive such as vinylene carbonate, propane sultone (PS), tert-butylbenzene (TBB), lithium bis(oxalate)borate (LiBOB), or a dinitrile compound such as succinonitrile or adiponitrile may be added to the electrolyte. The concentration of the additive in the whole electrolyte is, for example, higher than or equal to 0.1 volume % and lower than 5 volume %.

The electrolyte may contain one or more aprotic organic solvents such as γ-butyrolactone, acetonitrile, dimethoxyethane, and tetrahydrofuran, in addition to the above.

When a gelled high-molecular material is contained in the electrolyte, safety against liquid leakage and the like is improved. Typical examples of gelled high-molecular materials include a silicone gel, an acrylic gel, an acrylonitrile gel, a polyethylene oxide-based gel, a polypropylene oxide-based gel, and a gel of a fluorine-based polymer.

As the high-molecular material, for example, a polymer having a polyalkylene oxide structure, such as polyethylene oxide (PEO); PVDF; polyacrylonitrile; a copolymer containing any of them; and the like can be used. For example, PVDF-HFP, which is a copolymer of PVDF and hexafluoropropylene (HFP), can be used. The formed polymer may be porous.

### [Separator]

A separator is placed between the positive electrode and the negative electrode. As the separator, for example, fiber containing cellulose such as paper; nonwoven fabric; glass fiber; ceramics; synthetic fiber using a nylon resin (polyamide), a vinylon resin (polyvinyl alcohol-based fiber), a polyester resin, an acrylic resin, a polyolefin resin, or a polyurethane resin; or the like can be used. The separator is preferably formed to have an envelope-like shape to wrap one of the positive electrode and the negative electrode.

The separator is a porous material having a pore with a size of approximately 20 nm, preferably a pore with a size of greater than or equal to 6.5 nm, further preferably a pore with a diameter of at least 2 nm.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, deterioration of the separator in charge and discharge at a high voltage can be suppressed and thus the reliability of the secondary battery can be improved. When the separator is coated with the fluorine-based material, the separator is easily brought into close contact with an electrode, resulting in high output characteristics. When the separator is coated with the polyamide-based material, in particular, aramid, the safety of the secondary battery can be improved because heat resistance is improved.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With the use of a separator having a multilayer structure, the capacity per volume of the secondary battery can be increased because the safety of the secondary battery can be maintained even when the total thickness of the separator is small.

### [Exterior Body]

As an exterior body included in the secondary battery, a can-type exterior body using a metal material such as aluminum or a case-type exterior body using a resin material can be used, for example. A film-like exterior body can also be used. As the film, for example, it is possible to use a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body. As the film, a fluorine resin film is preferably used. The fluorine resin film has high stability to acid, alkali, an organic solvent, and the like and suppresses a side reaction, corrosion, or the like caused by a reaction of a secondary battery or the like, whereby an excellent secondary battery can be provided. Examples of the fluorine resin film include PTFE (polytetrafluoroethylene), PFA (perfluoroalkoxy alkane: a copolymer of tetrafluoroethylene and perfluoroalkyl vinyl ether), FEP (a perfluoroethylene-propene copolymer: a copolymer of tetrafluoroethylene and hexafluoropropylene), and ETFE (an ethylene-tetrafluoroethylene copolymer: a copolymer of tetrafluoroethylene and ethylene).

This embodiment can be used in appropriate combination with the other embodiments.

### Embodiment 3

This embodiment describes specific structure examples of the secondary battery described in the above embodiment.

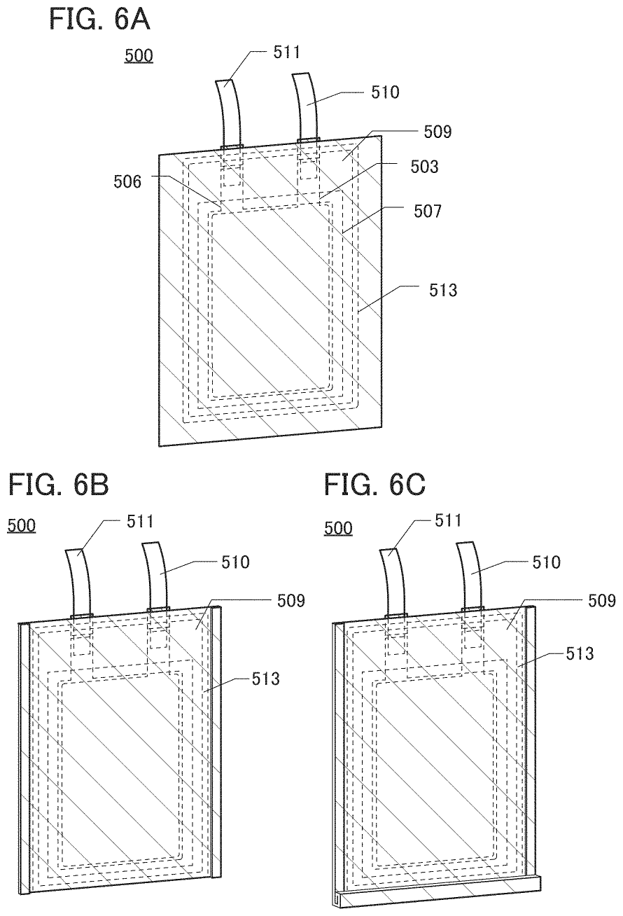

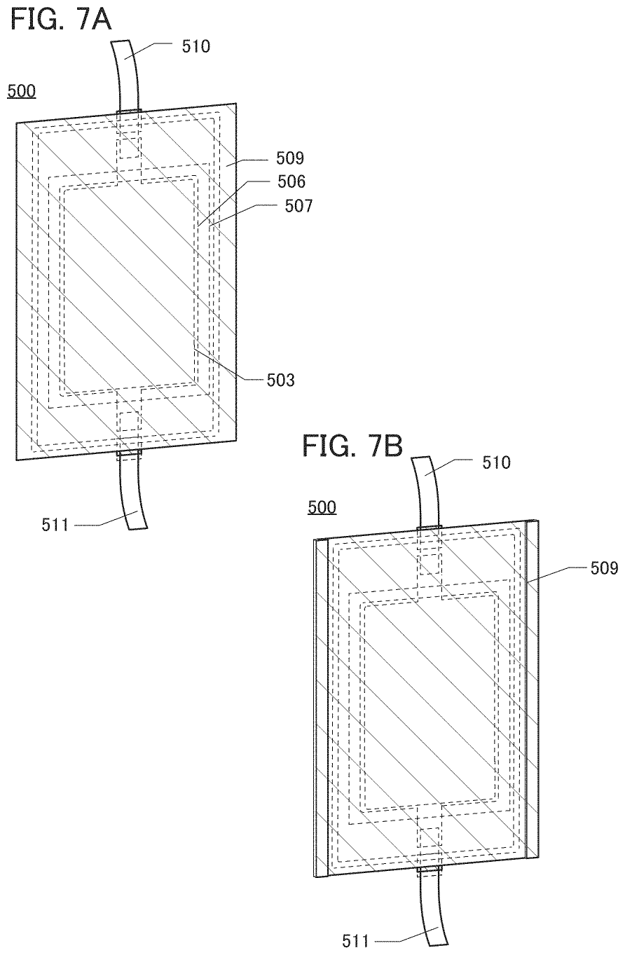

FIG. 6 and FIG. 7 illustrate examples of the external views for structure examples of the secondary battery of one embodiment of the present invention.

The secondary battery illustrated in FIG. 6A includes the positive electrode 503, the negative electrode 506, the separator 507, and the exterior body 509. The exterior body 509 is sealed with the seal region 513. The positive electrode 503, the negative electrode 506, and the separator 507 are stacked and placed inside the exterior body 509.

In FIG. 6A, a positive electrode lead electrode 510 is bonded to the positive electrode 503. The positive electrode lead electrode 510 is exposed to the outside of the exterior body 509. A negative electrode lead electrode 511 is bonded to the negative electrode 506, and the negative electrode lead electrode 511 is exposed to the outside of the exterior body 509.

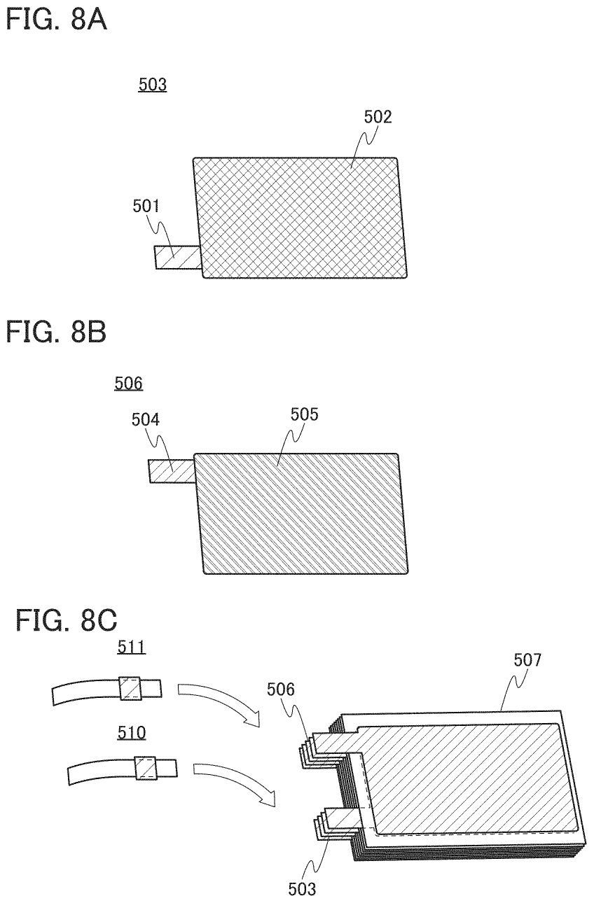

Bonding of the lead electrodes will be described with reference to FIG. 8A, FIG. 8B, and FIG. 8C.

FIG. 8A is an external view of the positive electrode 503. The positive electrode 503 includes the positive electrode current collector 501, and the positive electrode active material layer 502 is formed on the surface of the positive electrode current collector 501. The positive electrode 503 also includes a region where the positive electrode current collector 501 is partly exposed (hereinafter, referred to as a tab region).

FIG. 8B is an external view of the negative electrode 506. The negative electrode 506 includes the negative electrode current collector 504, and the negative electrode active material layer 505 is formed on the surface of the negative electrode current collector 504. The negative electrode 506 also includes a region where the negative electrode current collector 504 is partly exposed, that is, a tab region. The areas or the shapes of the tab regions included in the positive electrode and the negative electrode are not limited to the examples illustrated in FIG. 8A and FIG. 8B.

FIG. 8C is a diagram illustrating bonding of the lead electrodes. First, the negative electrode 506, the separator 507, and the positive electrode 503 are stacked. FIG. 8C illustrates a stack of the negative electrode 506, the separator 507, and the positive electrode 503. Here, the stack of the negative electrode, the separator, and the positive electrode includes five negative electrodes and four positive electrodes. The tab regions of the positive electrodes 503 are bonded to each other, and the positive electrode lead electrode 510 is bonded to the tab region of the positive electrode on the outermost surface. The bonding is performed by ultrasonic welding or the like, for example. In a similar manner, the tab regions of the negative electrodes 506 are bonded to each other, and the negative electrode lead electrode 511 is bonded to the tab region of the negative electrode on the outermost surface.

The external view shown in FIG. 6B illustrates an example in which end portions are folded at two sides of the side surfaces of the exterior body 509. Folding the end portions of the exterior body 509 can increase the strength of the exterior body 509. In the case where external force is applied to the secondary battery 500 or in the case where the secondary battery 500 is expanded because of generation of a gas or the like inside the exterior body 509, for example, a problem such as loosened sealing can be reduced. FIG. 6C illustrates an example in which three sides are folded.

FIG. 6A, FIG. 6B, and FIG. 6C each illustrate an example in which the positive electrode lead electrode 510 and the negative electrode lead electrode 511 are placed on the same side; however, the positive electrode lead electrode 510 and the negative electrode lead electrode 511 may be placed on different sides, e.g., upper and lower sides as illustrated in FIG. 7A. FIG. 7B illustrates an example in which the left side and the right side of the exterior body 509 in FIG. 7A are folded.

This embodiment can be used in appropriate combination with the other embodiments.

### Embodiment 4

In this embodiment, an example in which a secondary battery is used in an electric vehicle (EV) will be described.

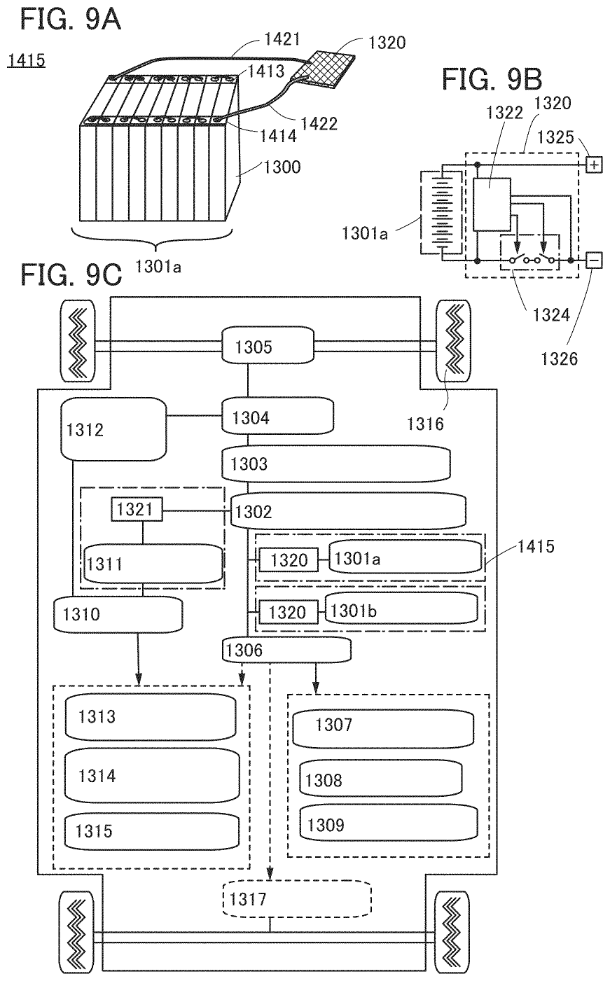

As illustrated in FIG. 9C, the electric vehicle is provided with first batteries 1301a and 1301b as main secondary batteries for driving and a second battery 1311 that supplies electric power to an inverter 1312 for starting a motor 1304. The second battery 1311 is also referred to as a cranking battery (a starter battery). The second battery 1311 needs high output and high capacity is not so necessary, and the capacity of the second battery 1311 is lower than that of the first batteries 1301a and 1301b.

As the first battery 1301a, a secondary battery using the method for fabricating a secondary battery described in Embodiment 1 can be used.

Although this embodiment shows an example in which the two first batteries 1301a and 1301b are connected in parallel, three or more batteries may be connected in parallel. In the case where the first battery 1301a can store sufficient electric power, the first battery 1301b may be omitted. With a battery pack including a plurality of secondary batteries, large electric power can be extracted. The plurality of secondary batteries may be connected in parallel, connected in series, or connected in series after being connected in parallel. The plurality of secondary batteries are also referred to as an assembled battery.

An in-vehicle secondary battery includes a service plug or a circuit breaker that can cut off high voltage without the use of equipment in order to cut off electric power from a plurality of secondary batteries. The first battery 1301a is provided with such a service plug or a circuit breaker.

Electric power from the first batteries 1301a and 1301b is mainly used to rotate the motor 1304 and is also supplied to in-vehicle parts for 42 V (such as an electric power steering 1307, a heater 1308, and a defogger 1309) through a DCDC circuit 1306. In the case where there is a rear motor 1317 for the rear wheels, the first battery 1301a is used to rotate the rear motor 1317.

The second battery 1311 supplies electric power to in-vehicle parts for 14 V (such as an audio 1313, power windows 1314, and lamps 1315) through a DCDC circuit 1310.

The first battery 1301a is described with reference to FIG. 9A.

FIG. 9A illustrates an example in which nine rectangular secondary batteries 1300 form one battery pack 1415. The nine rectangular secondary batteries 1300 are connected in series; one electrode of each battery is fixed by a fixing portion 1413 made of an insulator, and the other electrode thereof is fixed by a fixing portion 1414 made of an insulator. Although this embodiment shows an example in which the secondary batteries are fixed by the fixing portions 1413 and 1414, they may be stored in a battery container box (also referred to as a housing). Since a vibration or a jolt is assumed to be given to the vehicle from the outside (e.g., a road surface), the plurality of secondary batteries are preferably fixed with a battery container box or the like by the fixing portions 1413 and 1414. Furthermore, the one electrode is electrically connected to a control circuit portion 1320 through a wiring 1421. The other electrode is electrically connected to the control circuit portion 1320 through a wiring 1422.

The control circuit portion 1320 may include a memory circuit including a transistor using an oxide semiconductor. A charge control circuit or a battery control system that includes a memory circuit including a transistor using an oxide semiconductor may be referred to as a BTOS (Battery operating system or Battery oxide semiconductor).

The control circuit portion 1320 senses a terminal voltage of the secondary battery and controls the charge and discharge state of the secondary battery. For example, to prevent overcharge, an output transistor of a charge circuit and an interruption switch can be turned off substantially at the same time.

FIG. 9B illustrates an example of a block diagram of the battery pack 1415 illustrated in FIG. 9A.

The control circuit portion 1320 includes a switch portion 1324 that includes at least a switch for preventing overcharge and a switch for preventing overdischarge, a control circuit 1322 for controlling the switch portion 1324, and a portion for measuring the voltage of the first battery 1301a. The control circuit portion 1320 is set to have the upper limit voltage and the lower limit voltage of the secondary battery to be used, and imposes the upper limit of current from the outside, the upper limit of output current to the outside, or the like. The range from the lower limit voltage to the upper limit voltage of the secondary battery falls within the recommended voltage range, and when a voltage falls outside the range, the switch portion 1324 operates and functions as a protection circuit. The control circuit portion 1320 can also be referred to as a protection circuit because it controls the switch portion 1324 to prevent overdischarge or overcharge. For example, when the control circuit 1322 detects a voltage that is likely to cause overcharge, current is interrupted by turning off the switch in the switch portion 1324. Furthermore, a function of interrupting current in accordance with a temperature rise may be set by providing a PTC element in the charge and discharge path. The control circuit portion 1320 includes an external terminal 1325 (+IN) and an external terminal 1326 (−IN).

The switch portion 1324 can be formed by a combination of an n-channel transistor and a p-channel transistor. The switch portion 1324 is not limited to a switch including a Si transistor using single crystal silicon; the switch portion 1324 may be formed using a power transistor containing Ge (germanium), SiGe (silicon germanium), GaAs (gallium arsenide), GaAlAs (gallium aluminum arsenide), InP (indium phosphide), SiC (silicon carbide), ZnSe (zinc selenide), GaN (gallium nitride), GaOₓ (gallium oxide, where x is a real number greater than 0), or the like. A memory element using an OS transistor can be freely placed by being stacked over a circuit using a Si transistor, for example; hence, integration can be easy. Furthermore, an OS transistor can be fabricated with a manufacturing apparatus similar to that for a Si transistor and thus can be fabricated at low cost. That is, the control circuit portion 1320 using OS transistors can be stacked over the switch portion 1324 so that they can be integrated into one chip. Since the area occupied by the control circuit portion 1320 can be reduced, a reduction in size is possible.

The first batteries 1301a and 1301b mainly supply electric power to in-vehicle parts for 42 V (for a high-voltage system), and the second battery 1311 supplies electric power to in-vehicle parts for 14 V (for a low-voltage system). Lead batteries are usually used for the second battery 1311 due to cost advantage.

In this embodiment, an example in which a lithium-ion secondary battery is used as both the first battery 1301a and the second battery 1311 is described. As the second battery 1311, a lead battery, an all-solid-state battery, or an electric double layer capacitor may be used.

Regenerative energy generated by rolling of tires 1316 is transmitted to the motor 1304 through a gear 1305, and is stored in the second battery 1311 from a motor controller 1303 or a battery controller 1302 through a control circuit portion 1321. Alternatively, the regenerative energy is stored in the first battery 1301a from the battery controller 1302 through the control circuit portion 1320. Alternatively, the regenerative energy is stored in the first battery 1301b from the battery controller 1302 through the control circuit portion 1320. For efficient charge with regenerative energy, the first batteries 1301a and 1301b are desirably capable of fast charging.

The battery controller 1302 can set the charge voltage, charge current, and the like of the first batteries 1301a and 1301b. The battery controller 1302 can set charge conditions in accordance with charge characteristics of a secondary battery to be used, so that fast charging can be performed.

Although not illustrated, in the case of connection to an external charger, a plug of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharge, the first batteries 1301a and 1301b are preferably charged through the control circuit portion 1320. In addition, a connection cable or a connection cable of the charger is sometimes provided with a control circuit. The control circuit portion 1320 is also referred to as an ECU (Electronic Control Unit). The ECU is connected to a CAN (Controller Area Network) provided in the electric vehicle. The CAN is a type of a serial communication standard used as an in-vehicle LAN. The ECU includes a microcomputer. Moreover, the ECU uses a CPU or a GPU.

Next, examples in which the secondary battery of one embodiment of the present invention is mounted on a vehicle, typically a transport vehicle, will be described.

By incorporating the secondary battery of one embodiment of the present invention into vehicles, next-generation clean energy vehicles such as hybrid vehicles (HVs), electric vehicles (EVs), and plug-in hybrid vehicles (PHVs) can be achieved. The secondary battery can also be mounted on transport vehicles such as agricultural machines, motorized bicycles including motor-assisted bicycles, motorcycles, electric wheelchairs, electric carts, boats and ships, submarines, aircraft such as fixed-wing aircraft and rotary-wing aircraft, rockets, artificial satellites, space probes, planetary probes, and spacecraft. With the use of the method for fabricating a secondary battery described in Embodiment 1, a large secondary battery can be provided. Thus, the secondary battery of one embodiment of the present invention can be suitably used in transport vehicles.

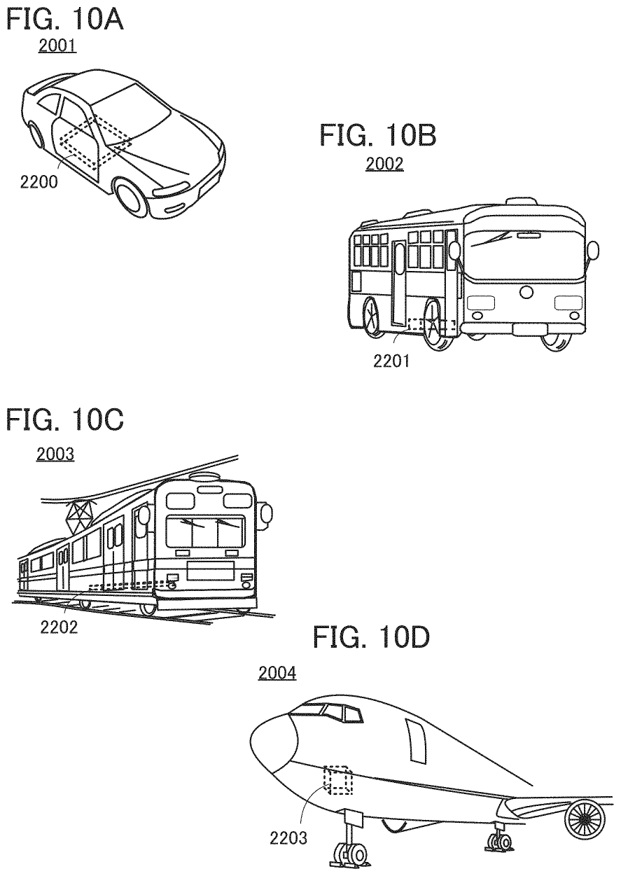

FIG. 10A to FIG. 10D illustrate examples of transport vehicles using one embodiment of the present invention. An automobile 2001 illustrated in FIG. 10A is an electric vehicle that runs on an electric motor as a power source. Alternatively, the automobile 2001 is a hybrid electric vehicle that can appropriately select an electric motor or an engine as a driving power source. In the case where the secondary battery is mounted on the vehicle, the secondary battery is provided at one position or several positions. The automobile 2001 illustrated in FIG. 10A includes a battery pack 2200, and the battery pack includes a secondary battery module in which a plurality of secondary batteries are connected to each other. Moreover, a charge control device that is electrically connected to the secondary battery module is preferably included.

The automobile 2001 can be charged when the secondary battery included in the automobile 2001 is supplied with electric power through external charge equipment by a plug-in system, a contactless power feeding system, or the like. In charging, a given method such as CHAdeMO (registered trademark) or Combined Charging System can be employed as a charge method, the standard of a connector, or the like as appropriate. The secondary battery may be a charge station provided in a commerce facility or a power source in a house. For example, with the use of the plug-in technique, a power storage device mounted on the automobile 2001 can be charged by being supplied with electric power from the outside. The charge can be performed by converting AC electric power into DC electric power through a converter such as an ACDC converter.

Although not illustrated, the vehicle may include a power receiving device so that it can be charged by being supplied with electric power from an above-ground power transmitting device in a contactless manner. In the case of the contactless power feeding system, by fitting a power transmitting device in a road or an exterior wall, charge can be performed not only when the vehicle is stopped but also when driven. In addition, the contactless power feeding system may be utilized to perform transmission and reception of electric power between two vehicles. Furthermore, a solar cell may be provided in the exterior of the vehicle to charge the secondary battery when the vehicle stops or moves. To supply electric power in such a contactless manner, an electromagnetic induction method or a magnetic resonance method can be used.

FIG. 10B illustrates a large transporter 2002 having a motor controlled by electricity as an example of a transport vehicle. A secondary battery module of the transporter 2002 includes a cell unit of four secondary batteries with 3.5 V or higher and 4.7 V or lower, for example, and 48 cells are connected in series to have a maximum voltage of 170 V. A battery pack 2201 has the same function as that in FIG. 10A except, for example, the number of secondary batteries configuring the secondary battery module; thus, the description is omitted.

FIG. 10C illustrates a large transport vehicle 2003 having a motor controlled by electricity as an example. The secondary battery module of the transport vehicle 2003 has 100 or more secondary batteries with 3.5 V or higher and 4.7 V or lower connected in series, and the maximum voltage is 600 V, for example. Thus, the secondary batteries are required to have a small variation in the characteristics. With the use of the method for fabricating a secondary battery described in Embodiment 1, a secondary battery with stable battery performance can be manufactured, and mass production at low cost is possible in view of the yield. A battery pack 2202 has the same function as that in FIG. 10A except, for example, the number of secondary batteries configuring the secondary battery module; thus, the description is omitted.

FIG. 10D illustrates an aircraft 2004 having a combustion engine as an example. The aircraft 2004 illustrated in FIG. 10D is regarded as a kind of transport vehicles because it has wheels for takeoff and landing, and includes a battery pack 2203 that includes a charge control device and a secondary battery module configured by connecting a plurality of secondary batteries.

The secondary battery module of the aircraft 2004 has eight 4 V secondary batteries connected in series and has a maximum voltage of 32 V, for example. The battery pack 2203 has the same function as that in FIG. 10A except, for example, the number of secondary batteries configuring the secondary battery module; thus, the description is omitted.

This embodiment can be used in appropriate combination with the other embodiments.

### Embodiment 5

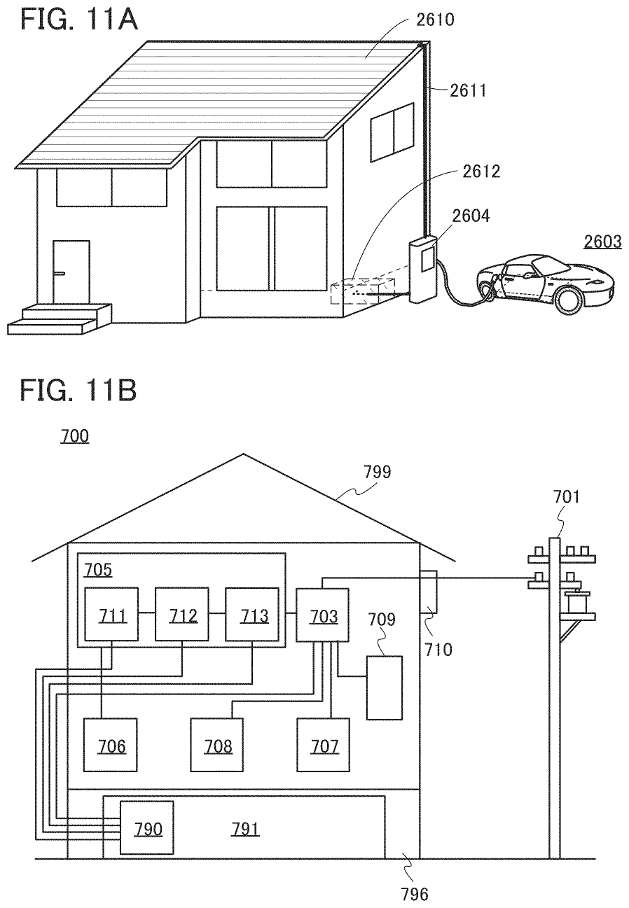

In this embodiment, examples in which the secondary battery of one embodiment of the present invention is mounted on a building will be described with reference to FIG. 11A and FIG. 11B.

A house illustrated in FIG. 11A includes a power storage device 2612 including the secondary battery that has stable battery performance by using the method for fabricating a secondary battery described in Embodiment 1 and a solar panel 2610. The power storage device 2612 is electrically connected to the solar panel 2610 through a wiring 2611 or the like. The power storage device 2612 may be electrically connected to ground-based charge equipment 2604. The power storage device 2612 can be charged with electric power generated by the solar panel 2610. The secondary battery included in a vehicle 2603 can be charged with the electric power stored in the power storage device 2612 through the charge equipment 2604. The power storage device 2612 is preferably provided in an underfloor space. The power storage device 2612 is provided in the underfloor space, in which case the space on the floor can be effectively used. Alternatively, the power storage device 2612 may be provided on the floor.

The electric power stored in the power storage device 2612 can also be supplied to other electronic devices in the house. Thus, with the use of the power storage device 2612 as an uninterruptible power source, electronic devices can be used even when electric power cannot be supplied from a commercial power source due to power failure or the like.

FIG. 11B illustrates an example of a power storage device 700 of one embodiment of the present invention. As illustrated in FIG. 11B, a large power storage device 791 obtained by the method for fabricating a secondary battery described in Embodiment 1 is provided in an underfloor space 796 of a building 799.

The power storage device 791 is provided with a control device 790, and the control device 790 is electrically connected to a distribution board 703, a power storage controller 705 (also referred to as a control device), an indicator 706, and a router 709 through wirings.

Electric power is transmitted from a commercial power source 701 to the distribution board 703 through a service wire mounting portion 710. Moreover, electric power is transmitted to the distribution board 703 from the power storage device 791 and the commercial power source 701, and the distribution board 703 supplies the transmitted electric power to a general load 707 and a power storage load 708 through outlets (not illustrated).

The general load 707 is, for example, an electric device such as a TV or a personal computer. The power storage load 708 is, for example, an electric device such as a microwave oven, a refrigerator, or an air conditioner.

The power storage controller 705 includes a measuring portion 711, a predicting portion 712, and a planning portion 713. The measuring portion 711 has a function of measuring the amount of electric power consumed by the general load 707 and the power storage load 708 during a day (e.g., from midnight to midnight). The measuring portion 711 may have a function of measuring the amount of electric power of the power storage device 791 and the amount of electric power supplied from the commercial power source 701. The predicting portion 712 has a function of predicting, on the basis of the amount of electric power consumed by the general load 707 and the power storage load 708 during a given day, the demand for electric power consumed by the general load 707 and the power storage load 708 during the next day. The planning portion 713 has a function of making a charge and discharge plan of the power storage device 791 on the basis of the demand for electric power predicted by the predicting portion 712.

The amount of electric power consumed by the general load 707 and the power storage load 708 and measured by the measuring portion 711 can be checked with the indicator 706. It can be checked with an electric device such as a TV or a personal computer through the router 709. Furthermore, it can be checked with a portable electronic terminal such as a smartphone or a tablet through the router 709. With the indicator 706, the electric device, or the portable electronic terminal, for example, the demand for electric power depending on a time period (or per hour) that is predicted by the predicting portion 712 can be checked.

This embodiment can be used in appropriate combination with the other embodiments.

### Embodiment 6

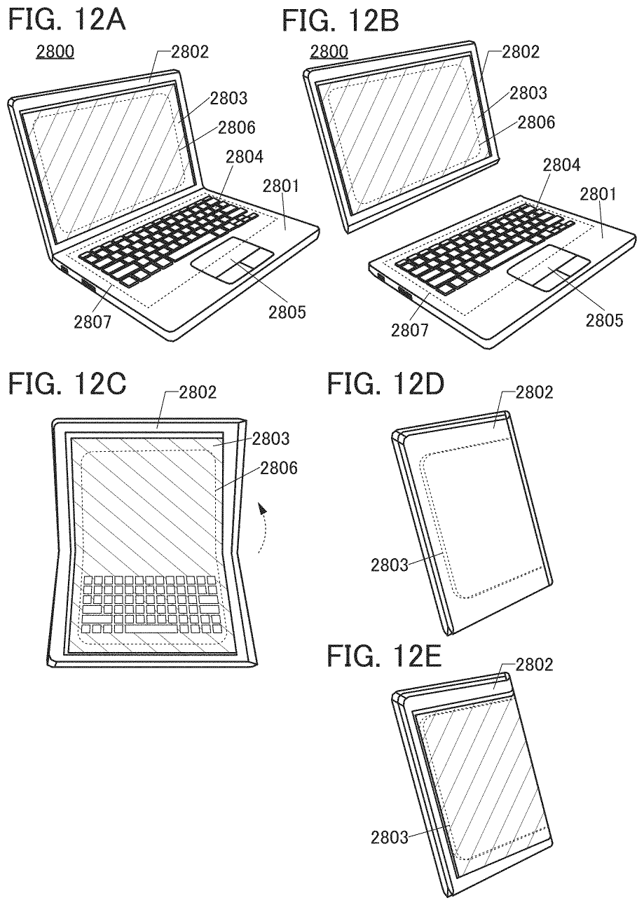

A personal computer 2800 illustrated in FIG. 12A includes a housing 2801, a housing 2802, a display portion 2803, a keyboard 2804, a pointing device 2805, and the like. A secondary battery 2806 is provided inside the housing 2801, and a secondary battery 2807 is provided inside the housing 2802. A touch panel is used for the display portion 2803. As illustrated in FIG. 12B, the housing 2801 and the housing 2802 of the personal computer 2800 can be detached and the housing 2802 can be used alone as a tablet terminal.

A large secondary battery obtained by the method for fabricating a secondary battery described in Embodiment 1 can be used as the secondary battery 2807. The secondary battery obtained by the method for fabricating a secondary battery described in Embodiment 1 can have higher capacity of the secondary battery and can lengthen the operating time of the personal computer 2800. In addition, the personal computer 2800 can be more lightweight.

A flexible display is used for the display portion 2803 of the housing 2802. A large secondary battery obtained by the method for fabricating a secondary battery described in Embodiment 1 is used as the secondary battery 2807. With the use of a flexible film as an exterior body in a large secondary battery obtained by the method for fabricating a secondary battery described in Embodiment 1, a foldable secondary battery can be obtained. Thus, as illustrated in FIG. 12C, the housing 2802 can be used while being folded. At this time, part of the display portion 2803 can also be used as a keyboard, as illustrated in FIG. 12C.

Furthermore, the housing 2802 can be folded such that the display portion 2803 is placed inward as illustrated in FIG. 12D, and the housing 2802 can be folded such that the display portion 2803 faces outward as illustrated in FIG. 12E.

This embodiment can be used in appropriate combination with the other embodiments.

(Notes on Description of this Specification and the Like)

In this specification and the like, crystal planes and orientations are indicated by the Miller index. In the crystallography, a bar is placed over a number in the expression of crystal planes and orientations; however, in this specification and the like, because of application format limitations, crystal planes and orientations may be expressed by placing − (a minus sign) at the front of a number instead of placing a bar over the number. Furthermore, an individual direction that shows an orientation in a crystal is denoted by “[ ]”, a set direction that shows all of the equivalent orientations is denoted by “< >”, an individual plane that shows a crystal plane is denoted by “( )”, and a set plane having equivalent symmetry is denoted by “{ }”.

In this specification and the like, segregation refers to a phenomenon in which, in a solid made of a plurality of elements (e.g., A, B, and C), a certain element (e.g., B) is spatially non-uniformly distributed.

In this specification and the like, a surface portion of a particle of an active material or the like is preferably a region that is less than or equal to 50 nm, further preferably less than or equal to 35 nm, still further preferably less than or equal to 20 nm from the surface, for example. A plane generated by a split or a crack may also be referred to as a surface. In addition, a region whose position is deeper than that of the surface portion is referred to as an inner portion.

In this specification and the like, a layered rock-salt crystal structure of a composite oxide containing lithium and a transition metal refers to a crystal structure in which a rock-salt ion arrangement where cations and anions are alternately arranged is included and lithium and the transition metal are regularly arranged to form a two-dimensional plane, so that lithium can be diffused two-dimensionally. Note that a defect such as a cation or anion vacancy may exist. In the layered rock-salt crystal structure, strictly, a lattice of a rock-salt crystal is distorted in some cases.

In this specification and the like, a rock-salt crystal structure refers to a structure in which cations and anions are alternately arranged. Note that a cation or anion vacancy may exist.

The orientations of crystals in two regions being substantially aligned with each other can be judged, for example, from a TEM (transmission electron microscope) image, a STEM (scanning transmission electron microscope) image, a HAADF-STEM (high-angle annular dark field scanning transmission electron microscopy) image, an ABF-STEM (annular bright-field scanning transmission electron microscopy) image, or the like. X-ray diffraction (XRD), electron diffraction, neutron diffraction, and the like can also be used for judging. In a TEM image and the like, alignment of cations and anions can be observed as repetition of bright lines and dark lines. When the orientations of cubic close-packed structures in the layered rock-salt crystal and the rock-salt crystal are aligned, a state where an angle made by the repetition of bright lines and dark lines in the crystals is less than or equal to 5°, preferably less than or equal to 2.5° can be observed. Note that in a TEM image and the like, a light element typified by oxygen or fluorine cannot be clearly observed in some cases; in such a case, alignment of orientations can be judged by arrangement of metal elements.

In this specification and the like, a theoretical capacity of a positive electrode active material refers to the amount of electricity obtained when all lithium that can be inserted and extracted and is contained in the positive electrode active material is extracted. For example, the theoretical capacity of LiCoO₂ is 274 mAh/g, the theoretical capacity of LiNiO₂ is 274 mAh/g, and the theoretical capacity of LiMn₂O₄ is 148 mAh/g.

In this specification and the like, the charge depth obtained when all lithium that can be inserted and extracted is inserted is 0, and the charge depth obtained when all lithium that can be inserted and extracted and is contained in a positive electrode active material is extracted is 1.

In this specification and the like, charge refers to transfer of lithium ions from a positive electrode to a negative electrode in a battery and transfer of electrons from a positive electrode to a negative electrode in an external circuit. For a positive electrode active material, extraction of lithium ions is called charge. A positive electrode active material with a charge depth greater than or equal to 0.7 and less than or equal to 0.9 may be referred to as a positive electrode active material charged with a high voltage.

Similarly, discharge refers to transfer of lithium ions from a negative electrode to a positive electrode in a battery and transfer of electrons from a negative electrode to a positive electrode in an external circuit. For a positive electrode active material, insertion of lithium ions is called discharge. A positive electrode active material with a charge depth less than or equal to 0.06 or a positive electrode active material from which more than or equal to 90% of the charge capacity is discharged from a high-voltage charged state is referred to as a sufficiently discharged positive electrode active material.

In this specification and the like, an unbalanced phase change refers to a phenomenon that causes a nonlinear change in physical quantity. For example, an unbalanced phase change is presumed to occur around a peak in a dQ/dV curve obtained by differentiating capacitance (Q) with voltage (V) (dQ/dV), resulting in a large change in the crystal structure.

A secondary battery includes a positive electrode and a negative electrode, for example. A positive electrode active material is a material included in the positive electrode. The positive electrode active material is a substance that performs a reaction contributing to the charge and discharge capacity, for example. Note that the positive electrode active material may partly contain a substance that does not contribute to the charge and discharge capacity.

### REFERENCE NUMERALS

500: secondary battery, 501: positive electrode current collector, 502: positive electrode active material layer, 503: positive electrode, 504: negative electrode current collector, 505: negative electrode active material layer, 506: negative electrode, 507: separator, 509: exterior body, 510: positive electrode lead electrode, 511: negative electrode lead electrode, 513: seal region, 514: nozzle, 515a, 515b, 515c: electrolyte, 700: power storage device, 701: commercial power source, 703: distribution board, 705: power storage controller, 706: indicator, 707: general load, 708: power storage load, 709: router, 710: service wire mounting portion, 711: measuring portion, 712: predicting portion, 713: planning portion, 790: control device, 791: power storage device, 796: underfloor space, 799: building, 1300: rectangular secondary battery, 1301a: battery, 1301b: battery, 1302: battery controller, 1303: motor controller, 1304: motor, 1305: gear, 1306: DCDC circuit, 1307: electric power steering, 1308: heater, 1309: defogger, 1310: DCDC circuit, 1311: battery, 1312: inverter, 1313: audio, 1314: power window, 1315: lamps, 1316: tire, 1317: rear motor, 1320: control circuit portion, 1321: control circuit portion, 1322: control circuit, 1324: switch portion, 1325: external terminal, 1326: external terminal, 1413: fixing portion, 1414: fixing portion, 1415: battery pack, 1421: wiring, 1422: wiring, 2001: automobile, 2002: transporter, 2003: transport vehicle, 2004: aircraft, 2200: battery pack, 2201: battery pack, 2202: battery pack, 2203: battery pack, 2603: vehicle, 2604: charge equipment, 2610: solar panel, 2611: wiring, 2612: power storage device, 2800: personal computer, 2801: housing, 2802: housing, 2803: display portion, 2804: keyboard, 2805: pointing device, 2806: secondary battery, 2807: secondary battery

1. A method for fabricating a secondary battery, comprising:
dripping an electrolyte on one or more of a positive electrode, a separator, and a negative electrode;
impregnating the one or more of the positive electrode, the separator, and the negative electrode with the electrolyte and then reducing pressure; and
sealing a stack of the one or more of the positive electrode, the separator, and the negative electrode with an exterior film.

2. A method for fabricating a secondary battery, comprising:
arranging a plurality of stacks over an exterior film;
dripping an electrolyte on the plurality of stacks; and
performing sealing under reduced pressure and then dividing the exterior film into separate secondary batteries,
wherein each of the plurality of stacks comprises at least two of a positive electrode, a separator, and a negative electrode.

3. The method for fabricating a secondary battery, according to claim 1,
wherein the stack is stored to be surrounded by the exterior film.

4. The method for fabricating a secondary battery, according to claim 1, wherein the electrolyte comprises fluorine.

5. The method for fabricating a secondary battery, according to claim 1, to wherein the electrolyte comprises an ionic liquid.

6. A method for fabricating a secondary battery, comprising:
placing a positive electrode over a first exterior film;
dripping a first electrolyte on the positive electrode;
placing a separator over the positive electrode;
dripping a second electrolyte on the separator;
placing a negative electrode over the separator;
dripping a third electrolyte on the negative electrode;
placing a stack of the positive electrode, the separator, and the negative electrode under reduced pressure; and
sandwiching the stack between the first exterior film and a second exterior film to perform sealing.

7. The method for fabricating a secondary battery, according to claim 1, wherein at least one of the positive electrode and the negative electrode comprises graphene.

8. The method for fabricating a secondary battery, according to claim 1, wherein the positive electrode comprises a positive electrode active material layer on one or both surfaces of a positive electrode current collector.

9. The method for fabricating a secondary battery, according to claim 1, wherein the negative electrode comprises a negative electrode active material layer on one or both surfaces of a negative electrode current collector.

10. The method for fabricating a secondary battery, according to claim 2, wherein at least one of the positive electrode and the negative electrode comprises graphene.

11. The method for fabricating a secondary battery, according to claim 2, wherein the positive electrode comprises a positive electrode active material layer on one or both surfaces of a positive electrode current collector.

12. The method for fabricating a secondary battery, according to claim 2, wherein the negative electrode comprises a negative electrode active material layer on one or both surfaces of a negative electrode current collector.

13. The method for fabricating a secondary battery, according to claim 6, wherein at least one of the positive electrode and the negative electrode comprises graphene.

14. The method for fabricating a secondary battery, according to claim 6, wherein the positive electrode comprises a positive electrode active material layer on one or both surfaces of a positive electrode current collector.

15. The method for fabricating a secondary battery, according to claim 6, wherein the negative electrode comprises a negative electrode active material layer on one or both surfaces of a negative electrode current collector.

16. The method for fabricating a secondary battery, according to claim 2, wherein the plurality of stacks is stored to be surrounded by the exterior film.

17. The method for fabricating a secondary battery, according to claim 2, wherein the electrolyte comprises fluorine.

18. The method for fabricating a secondary battery, according to claim 2, wherein the electrolyte comprises an ionic liquid.
